(19) United States
(12) Patent Application Publication
(10) Pub. No.: US 2014/0064230 A1
(43) Pub. Date: Mar. 6, 2014

(54) BASE STATION

(71) Applicant: Takeo Miyato, Yokohama-shi (JP)

(72) Inventor: Takeo Miyato, Yokohama-shi (JP)

(73) Assignee: KYOCERA CORPORATION, Kyoto-shi, Kyoto (JP)

(21) Appl. No.: 14/113,488

(22) PCT Filed: Apr. 25, 2012
(86) PCT No.: PCT/JP2012/061069

§ 371 Date: Oct. 23, 2013

(30) Foreign Application Priority Data
Apr. 26, 2011 (JP) 2011-098503

(51) Int. Cl. H04W 72/04

(52) U.S. Cl. CPC H04W 72/04
USPC 370/329

(57) ABSTRACT

When a scheduling executing section allocates a use downlink radio resource including in a frequency direction a frequency band, in which a known signal is not received by an uplink radio resource for known signal, from a downlink radio resource associated with the uplink radio resource for known signal to a communication terminal, a communication section generates a known signal to be received from the communication terminal in a frequency band of the use downlink radio resource in a pseudo manner when performing downlink communication with the communication terminal using the use downlink radio resource. The communication section controls transmission directivity in a plurality of antennas based on a new reception signal obtained by adding the pseudo known signal as a desired wave component to a reception signal that is received in the frequency band of the use downlink radio resource in the uplink radio resource for known signal.

### TECHNICAL FIELD

The present invention relates to a base station that communicates with a communication terminal using a plurality of antennas.

### BACKGROUND ART

A variety of techniques related to radio communication have been conventionally proposed. A technique relating to LTE (Long Term Evolution) is disclosed in Patent Document 1, for example. LTE is referred to also as “E-UTRA”.

### PRIOR ART DOCUMENT

### Patent Document

Patent Document 1: Japanese Patent Application Laid-Open No. 2008-099079

### SUMMARY OF THE INVENTION

### Problem to be Solved by the Invention

In base stations of LTE communication systems and the like, an adaptive array antenna system for adaptively controlling directivity in a plurality of antennas is occasionally adopted.

On the other hand, improvement in transmission performance is desired in the base stations.

Therefore, the present invention is devised in view of the above point, and its object is to provide a technique that is capable of controlling transmission directivity in the plurality of antennas and improving a transmission performance of a base station communicating with a communication terminal.

### Means for Solving the Problem

A base station from a certain aspect, for communicating with a communication terminal, includes a communication section for communicating with the communication terminal using a plurality of antennas and controlling transmission directivity in the plurality of antennas when downlink communication with the communication terminal is performed; and a scheduling executing section for determining a communication terminal for downlink communication and allocating, to the communication terminal, a use downlink radio resource to be used by the communication section for the downlink communication with the communication terminal, wherein a uplink radio resource for known signal which is capable of being used when the communication terminal transmits a known signal, and a downlink radio resource, which is associated with the uplink radio resource for known signal and is capable of being used when the communication section performs downlink communication with the communication terminal, are determined, when the scheduling executing section allocates the use downlink radio resource including a frequency band included in a transmission frequency band of the known signal in a frequency direction to the communication terminal that transmits the known signal using at least a part of the uplink radio resource for known signal, the scheduling executing section executes an allocating process for allocating the use downlink radio resource from the downlink radio resource associated with the uplink radio resource for known signal to the communication terminal, when the scheduling executing section executes the allocating process on the communication terminal transmitting the known signal using at least a part of the uplink radio resource for known signal, the communication section controls the transmission directivity in the plurality of antennas based on a reception signal including the known signal as a desired wave component received by at least part of the uplink radio resource for known signal when the downlink communication with the communication terminal is performed by using the use downlink radio resource, when the scheduling executing section allocates the use downlink radio resource including in the frequency direction a frequency band, in which the known signal is not received by the uplink radio resource for known signal, from the downlink radio resource associated with the uplink radio resource for known signal to the communication terminal, the communication section controls the transmission directivity in the plurality of antennas based on a new reception signal obtained by generating a known signal received from the communication terminal in the frequency band of the use downlink radio resource in a pseudo manner when performing the downlink communication with the communication terminal using the use downlink radio resource and by adding the pseudo known signal as a desired wave component to the reception signal received in the frequency band of the use downlink radio resource in the uplink radio resource for known signal.

### Effects of the Invention

According to the present invention, the transmission performance of the base station can be improved.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram illustrating a configuration of a communication system.

FIG. 2 is a diagram illustrating a configuration of a base station.

FIG. 3 is a diagram illustrating a configuration of a TDD frame.

FIG. 4 is a table illustrating the types of configurations of the TDD frame.

FIG. 5 is a diagram illustrating the details of the configuration of the TDD frame.

FIG. 6 is a diagram illustrating an example in which an SRS transmission band is frequency-hopped.

FIG. 7 is a diagram illustrating an SRS0 and an SRS1.

FIG. 8 is a diagram illustrating a plurality of uplink radio resources for SRS.

FIG. 9 is a diagram illustrating the operation of the communication system.

FIG. 10 is a diagram illustrating association unit period.

FIG. 11 is a diagram illustrating association between the uplink radio resources for SRS and downlink radio resources.

FIG. 12 is a diagram illustrating an example of allocation of the associated downlink radio resources.

FIG. 13 is a diagram describing first transmission control.

FIG. 14 is a diagram describing the first transmission control.

FIG. 15 is a diagram illustrating an example of allocation of the associated downlink radio resources.

FIG. 16 is a diagram illustrating an example of allocation of non-associated downlink radio resources.

FIG. 17 is a diagram describing second array transmission control.

FIG. 18 is a diagram describing second transmission control.

FIG. 19 is a flowchart illustrating the operation of the communication system.

FIG. 20 is a diagram describing the second transmission control.

### EMBODIMENT FOR CARRYING OUT THE INVENTION

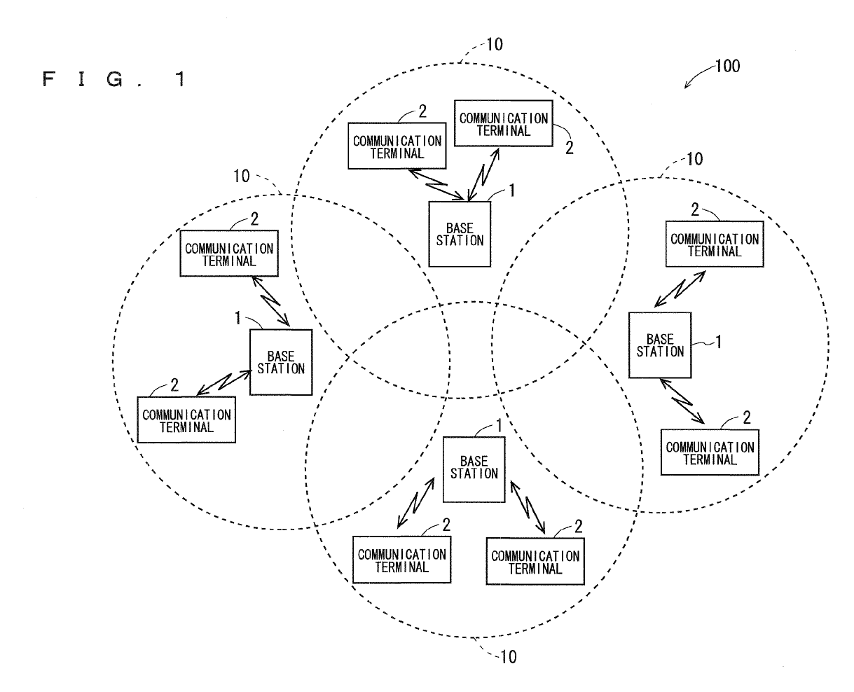

FIG. 1 is a diagram illustrating a configuration of a communication system 100 according to the embodiment. This communication system 100 is, for example, LTE in which a TDD (Time Division Duplexing) system is adopted as a duplex system, and includes a plurality of base stations 1. Each of the base stations 1 performs communications with a plurality of communication terminals 2. In LTE, an OFDMA (Orthogonal Frequency Division Multiple Access) system is used for downlink communication, and an SC-FDMA (Single Carrier-Frequency Division Multiple Access) system is used for uplink communication. Thus, the OFDMA system is used for transmission from the base stations 1 to the communication terminals 2, and the SC-FDMA system is used for transmission from the communication terminals 2 to the base stations 1. An OFDM (Orthogonal Frequency Division Multiplexing) signal in which a plurality of sub-carriers orthogonal to each other is combined together is used in the OFDMA system.

As shown in FIG. 1, each of the base stations 1 has a service area 10 which partially overlaps service areas 10 of its neighboring base stations 1. In FIG. 1, only two or three neighboring base stations 1 are present for each of the base stations 1 because only four base stations 1 are shown. In actuality, six neighboring base stations 1, for example, may be present for each of the base stations 1.

The plurality of base stations 1 is connected to a network not shown, and is capable of performing communications with each other via the network. A server device, not shown, is connected to the network, and each of the base stations 1 is capable of performing communications with the server device via the network.

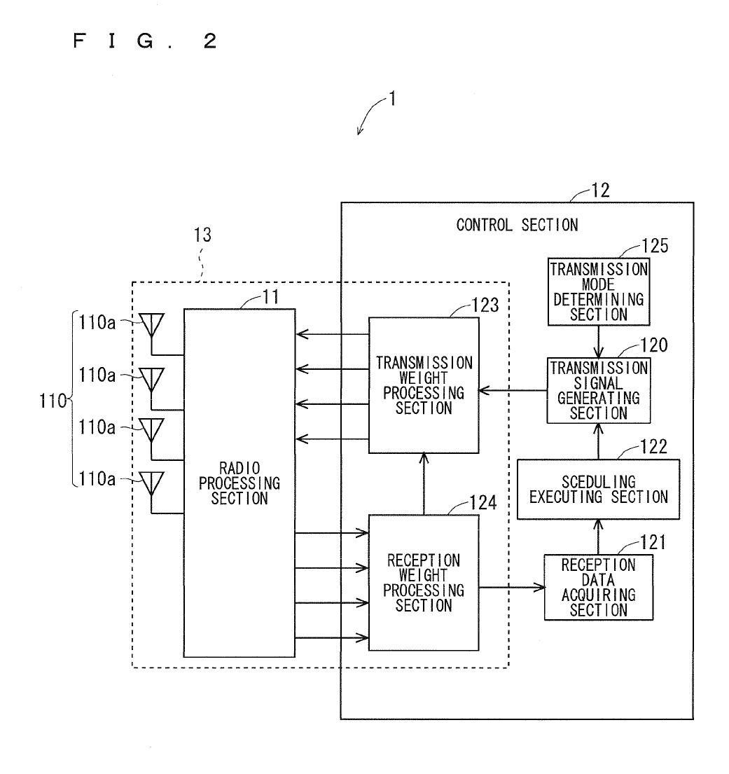

FIG. 2 is a diagram illustrating a configuration of each base station 1. Such a base station 1 is capable of performing communications with the plurality of communication terminals 2 at the same time by individually allocating radio resources specified by two-dimensions composed of a time axis and a frequency axis to the plurality of communication terminals 2, respectively. The base station 1 includes an array antenna as transmitting and receiving antennas, and is capable of controlling the directivity of the array antenna by using an adaptive array antenna system.

As shown in FIG. 2, the base station 1 includes a radio processing section 11, and a control section 12 for controlling the radio processing section 11. The radio processing section 11 includes an array antenna 110 composed of a plurality of antennas 110a. The radio processing section 11 performs an amplification process, down-converting, an A/D conversion process and the like on each of a plurality of reception signals received by the array antenna 110 to generate and output a plurality of baseband reception signals.

The radio processing section 11 also performs a D/A conversion process, up-converting, an amplification process and the like on each of a plurality of baseband transmission signals generated by the control section 12 to generate a plurality of carrier-band transmission signals. The radio processing section 11 then inputs the plurality of generated carrier-band transmission signals to the plurality of antennas 110a constituting the array antenna 110, respectively. Thus, the transmission signals are transmitted from the antennas 110a by radio.

The control section 12 includes a CPU (Central Processing Unit), a DSP (Digital Signal Processor), a memory and the like. In the control section 12, the CPU and the DSP execute various programs stored in the memory, so that a plurality of functional blocks, which includes a transmission signal generating section 120, a reception data acquiring section 121, a scheduling executing section 122, a transmission weight processing section 123, a reception weight processing section 124, a transmission mode determining section 125 and the like, are formed.

The transmission signal generating section 120 generates transmission data to be transmitted to the communication terminals 2 with which communication is performed. The transmission data includes control data and user data. The transmission signal generating section 120 then generates the baseband transmission signal including the generated transmission data. The generated transmission signals are equal in number to the plurality of the antennas 110a constituting the array antenna 110.

The transmission weight processing section 123 sets a plurality of transmission weights for controlling the transmission directivity of the array antenna 110 respectively to the plurality of transmission signals generated by the transmission signal generating section 120. The transmission weight processing section 123 then performs an inverse discrete Fourier transform (IDFT) and the like on the plurality of transmission signals to which the respective transmission weights are set, and thereafter outputs the plurality of transmission signals to the radio processing section 11.

The reception weight processing section 124 performs a discrete Fourier transform (DFT) on the plurality of reception signals input from the radio processing section 11, and thereafter sets a plurality of reception weights for controlling the reception directivity of the array antenna 110 respectively to the plurality of reception signals. The reception weight processing section 124 then synthesizes the plurality of reception signals to which the plurality of reception weights is set respectively so as to generate a new reception signal (referred to hereinafter as “synthesized reception signal”).

The reception data acquiring section 121 performs an inverse discrete Fourier transform, a demodulation process and the like on the synthesized reception signal generated in the reception weight processing section 124 to obtain the control data and the user data included in the synthesized reception signal.

The radio processing section 11, the transmission weight processing section 123 and the reception weight processing section 124 in the base station 1 according to the embodiment constitute a communication section 13 for performing communications with the plurality of communication terminals 2 while adaptively controlling the directivity of the array antenna 110. When performing communications with the communication terminals 2, the communication section 13 controls the reception directivity and the transmission directivity of the array antenna 110. Specifically, the communication section 13 adjusts the reception weights by which the reception signals are multiplied in the reception weight processing section 124 to thereby set beam and null of the reception directivity of the array antenna 110 in various directions. Further, the communication section 13 adjusts the transmission weights by which the transmission signals are multiplied in the transmission weight processing section 123 to thereby set beam and null of the transmission directivity of the array antenna 110 in various directions. The transmission weights may be determined from the reception weights, and the reception weights may be determined based on the known signals from the communication terminals 2.

The scheduling executing section 122 determines the communication terminal 2 which performs downlink communication of data, and allocates, to the communication terminal 2, the downlink radio resource (referred to hereinafter as a “use downlink radio resource”) to be used for downlink communication of data with the communication terminal 2. The transmission signal generating section 120 generates a transmission signal including data which should be transmitted to a communication terminal 2 based on the use downlink radio resource allocated to the communication terminal 2 by the scheduling executing section 122, and inputs the transmission signal to the transmission weight processing section 123 at a time based on the use downlink radio resource. Thus, the transmission signal including the data which should be transmitted to the communication terminal 2 is transmitted from the communication section 13 by using the use downlink radio resource allocated to the communication terminal 2. The transmission signal generating section 120 generates and outputs a transmission signal including the control data for notifying the communication terminal 2 about the use downlink radio resource allocated to the communication terminal 2 by the scheduling executing section 122. This allows the communication terminal 2 to know the use downlink radio resource which is used for the transmission of data thereto, thereby receiving data from the base station 1 thereto appropriately.

Further, the scheduling executing section 122 determines the communication terminal 2 that performs uplink communication of data, and allocates an uplink radio resource (referred to hereinafter as a “use uplink radio resource”) to be used for uplink communication of data with the communication terminal 2 to the communication terminal 2. The transmission signal generating section 120 generates and outputs a transmission signal including control data for notifying the communication terminal 2 about the use uplink radio resource allocated to the communication terminal 2 by the scheduling executing section 122. This allows the communication terminal 2 to know the use uplink radio resource which is used for the transmission of data to the base station 1, thereby transmitting the data to the base station 1 by radio through the use uplink radio resource.

The transmission mode determining section 125 determines a transmission mode (a transmission frequency band, a transmission cycle and the like) of a sounding reference signal (SRS) to be described later which is a known signal transmitted from the communication terminals 2. The transmission signal generating section 120 generates and outputs a transmission signal including control data for notifying a communication terminal 2 about the transmission mode of the SRS to be transmitted by the communication terminal 2 which is determined by the transmission mode determining section 125. As a result the communication terminal 2 knows the transmission mode (the transmission frequency band, the transmission cycle and the like) of the SRS to be transmitted therefrom, and transmits the SRS to the base station 1 based on the transmission mode.

<Configuration of TDD Frame>

Next, a TDD frame 300 for use between the base station 1 and the communication terminal 2 is described. The TDD frame 300 is specified by two-dimensions composed of a time axis and a frequency axis. The frequency bandwidth (system bandwidth) of the TDD frame 300 is 10 MHz, for example, and the time length of the TDD frame 300 is 10 ms. The base station 1 determines the use uplink radio resources and use downlink radio resources to be allocated to the communication terminals 2, respectively, based on the TDD frame 300.

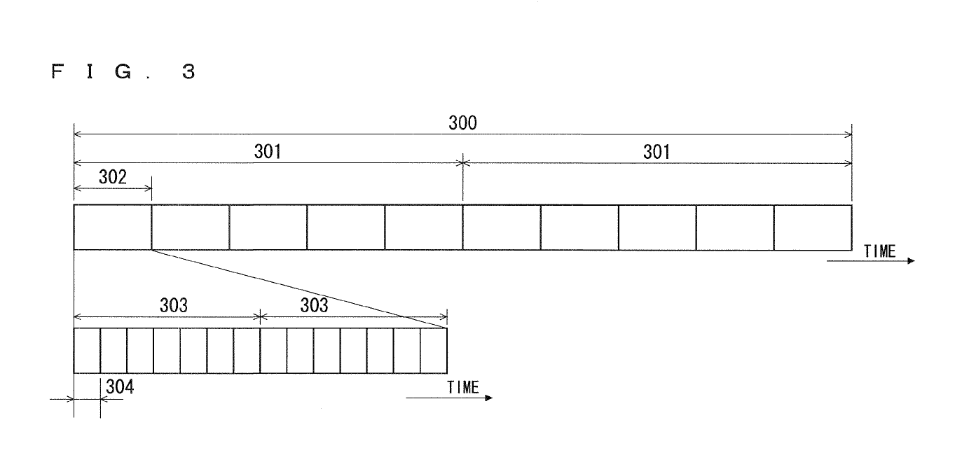

FIG. 3 is a diagram illustrating a configuration of the TDD frame 300. As shown in FIG. 3, the TDD frame 300 is composed of two half frames 301. Each of the half frames 301 is composed of five sub-frames 302. That is to say, the TDD frame 300 is composed of ten sub-frames 302. The time length of each of the sub-frames 302 is 1 ms. The ten sub-frames 302 constituting the TDD frame 300 are hereinafter referred to as zeroth to ninth sub-frames 302 in order from the leading end in some cases.

Each of the sub-frames 302 includes two slots 303 arranged in a time direction. Each of the slots 303 is composed of seven symbol periods 304. Therefore, each of the sub-frames 302 includes 14 symbol periods 304 arranged in a time direction. Such a symbol period 304 serves as one symbol period for an OFDM symbol in the downlink communication of the OFDMA system, and serves as one symbol period for a DFTS (Discrete Fourier Transform Spread)-OFDM symbol in the uplink communication of the SC-FDMA system.

The TDD frame 300 having the aforementioned configuration includes a sub-frame 302 for uplink communication only, and a sub-frame 302 for downlink communication only. The sub-frame 302 for uplink communication only is referred to as an “uplink sub-frame 302” and the sub-frame 302 for downlink communication only is referred to as a “downlink sub-frame 302” hereinafter. The communication terminals 2 transmit data to the base station 1 in the uplink sub-frame 302, and the base station 1 transmits data to the communication terminals 2 in the downlink sub-frame 302.

In LTE, a region (radio resource) of the TDD frame 300 which includes a frequency bandwidth of 180 kHz in a frequency direction and includes seven symbol periods 304 (one slot 303) in a time direction is referred to as a “resource block (RB)”. The resource block includes 12 sub-carriers. When allocating a use uplink radio resource to a communication terminal 2 or when allocating a use downlink radio resource to a communication terminal 2, the scheduling executing section 122 allocates the use uplink radio resource or the use downlink radio resource to the communication terminal 2 in units of two consecutive resource blocks, i.e., for each sub-frame 302, in the time direction and in units of one resource block in the frequency direction. When a plurality of resource blocks is allocated in the frequency direction to a certain communication terminal 2 in the uplink sub-frame 302, a plurality of resource blocks consecutive in the frequency direction is allocated to the communication terminal 2 because the SC-FDMA system is used in the uplink communication.

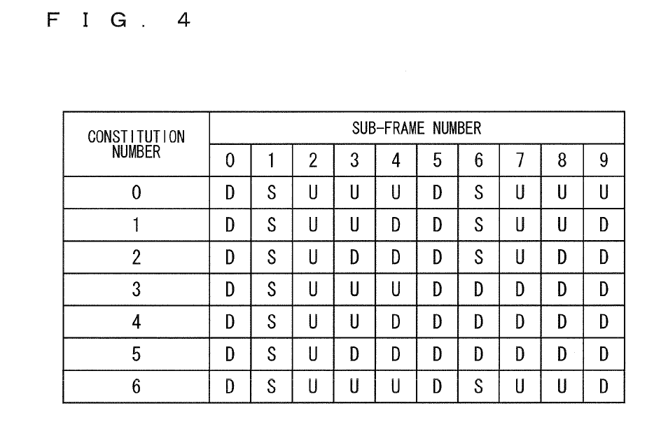

In LTE, seven types of configurations of the TDD frame 300 are specified. The configurations have different combinations of the uplink sub-frames 302 and the downlink sub-frames 302. FIG. 4 is a table illustrating the seven types of configurations.

As shown in FIG. 4, zeroth to sixth configurations of the TDD frames 300 are specified in LTE. In this communication system 100, one of the seven types of configurations is used. In FIG. 4, the sub-frame 302 denoted by “D” means the downlink sub-frame 302, and the sub-frame 302 denoted by “U” means the uplink sub-frame 302. Further, the sub-frame 302 denoted by “S” means the sub-frame 302 in which switching from the downlink communication to the uplink communication is done in the communication system 100. The sub-frame 302 of this type is referred to as a “special sub-frame 302”.

For example, in the TDD frame 300 having the zeroth configuration, the zeroth and fifth sub-frames 302 are the downlink sub-frames 302, the second to fourth sub-frames 302 and the seventh to ninth sub-frames 302 are the uplink sub-frames 302, and the first and sixth sub-frames 302 are the special sub-frames 302. Further, in the TDD frame 300 having the fourth configuration, the zeroth sub-frame 302 and the fourth to ninth sub-frames 302 are the downlink sub-frames 302, the second and third sub-frames 302 are the uplink sub-frames 302, and the first sub-frame 302 is the special sub-frame 302.

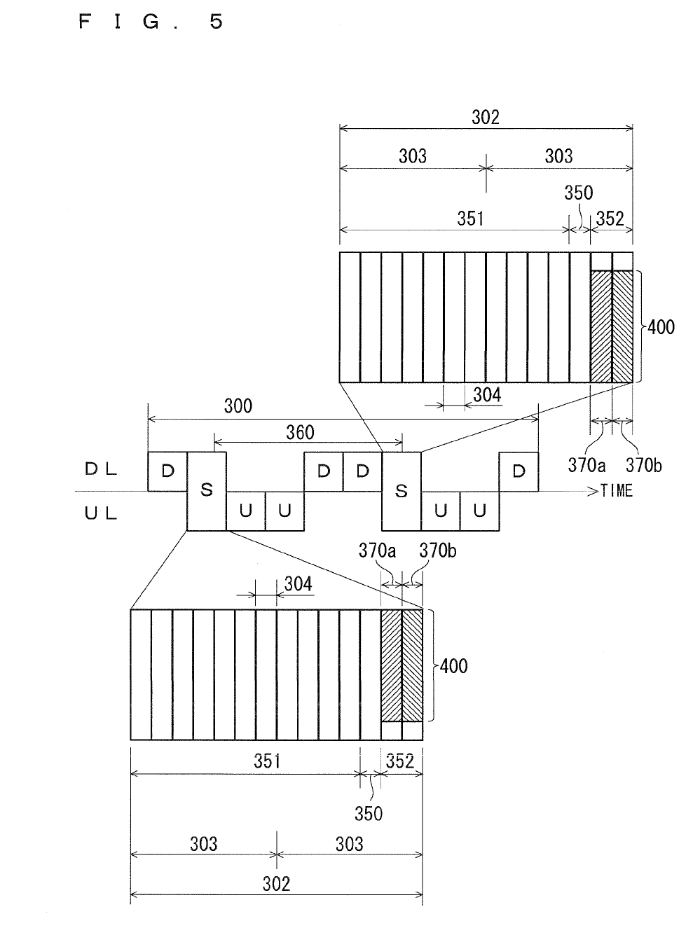

FIG. 5 is a diagram illustrating details of the configuration of the TDD frame 300 having the first configuration. As shown in FIG. 5, the special sub-frame 302 includes a downlink pilot time slot (DwPTS) 351, a guard time (GP) 350, and an uplink pilot time slot (UpPTS) 352 in the time direction. The guard time 350 is a no-signal time period required for the switching from the downlink communication to the uplink communication, and is not used for communication. In the following description, the TDD frame 300 having the first configuration shall be used in the communication system 100.

A plurality of types of combinations of time lengths of the downlink pilot time slot 351, the guard time 350 and the uplink pilot time slot 352 are specified in LTE. In the example of FIG. 5, the time length of the downlink pilot time slot 351 is set to 11 symbol periods 304, and the time length of the uplink pilot time slot 352 is set to 2 symbol periods 304.

In the communication system 100 according to the embodiment, the downlink communication is allowed to be performed not only in the downlink sub-frame 302 but also in the downlink pilot time slot 351 of the special sub-frame 302. Further, in this communication system 100, the uplink communication is allowed to be performed not only in the uplink sub-frame 302 but also in the uplink pilot time slot 352 of the special sub-frame 302.

In the embodiment, the base station 1 transmits data to the communication terminal 2 in each of the symbol periods 304 of the downlink pilot time slot 351. Each of the communication terminals 2 transmits a known signal referred to as the SRS in one of the two symbol periods 304 of the uplink pilot time slot 352. The SRS is composed of a plurality of complex symbols which modulates a plurality of sub-carriers. Hereinafter, the complex symbols included in the SRS are referred to as “SRS symbols”. In the embodiment, the SRS transmitted in the uplink pilot time slot 352 is used for calculation of the transmission weight. In other words, the communication section 13 in the base station 1 is capable of controlling transmission directivity of array antenna 110 based on the SRS transmitted by the communication terminal 2 in the uplink pilot time slot 352. The control of the transmission directivity of the array antenna 110 is hereinafter referred to as “array transmission control”.

The SRS can be transmitted in the last symbol period 304 of the uplink sub-frame 302. In other words, the communication terminals 2 are able to transmit data in the symbol periods 304 other than the last symbol period 304 of the uplink sub-frame 302, and to transmit the SRS in the last symbol period 304. For the array transmission control, the SRS transmitted in the last symbol period 304 of the uplink sub-frame 302 may be used, but the SRS transmitted in the uplink pilot time slot 352 shall be used in the embodiment. The SRS shall mean the SRS transmitted using the uplink pilot time slot 352 hereinafter unless otherwise specified. Further, a leading one of the symbol period 304 and a trailing one of the symbol period 304 included in the uplink pilot time slot 352 in which the communication terminals 2 can transmit the SRS are referred to as a “first uplink communication period for SRS 370a” and a “second uplink communication period for SRS 370b”, respectively. Further, the first uplink communication period for SRS 370a and the second uplink communication period for SRS 370b are each referred to as an “uplink communication period for SRS” unless otherwise discriminated.

Each of the communication terminals 2 transmits the SRS periodically. The length of an SRS transmission cycle (transmission interval) can be changed. The transmission cycle of the SRS is referred to as an “SRS transmission cycle 360”, hereinafter. In the example of FIG. 5, the length of the SRS transmission cycle 360 in each of the communication terminals 2 is set to 5 ms. Therefore, in the example of FIG. 5, each of the communication terminals 2 transmits the SRS in each of the uplink pilot time slots 352 of the uplink special sub-frame 302.

<Transmission Frequency Band of SRS>

In the communication system 100, for each of the communication terminals 2, frequency bands 400 (hereinafter referred to as “SRS transmittable bands 400”) which can be used for transmission of SRS by each of the communication terminals 2 are arranged alternately on a high-frequency side and a low-frequency side of the system band at every SRS transmission cycle 360 for the communication terminals 2. In FIG. 5, the SRS transmittable band 400 of the communication terminals 2 where the length of the SRS transmission cycle 360 is 5 ms and the SRS is transmitted in the first uplink communication period for SRS 370a is diagonally shaded from bottom left to top right, and the SRS transmittable band 400 of the communication terminals 2 where the length of the SRS transmission cycle 360 is 5 ms and the SRS is transmitted in the second uplink communication period for SRS 370b is diagonally shaded from top left to bottom right. When the system bandwidth is 10 MHz, the SRS transmittable band 400 is a frequency band for 40 resource blocks (180 kHz×40). In this embodiment, for example, the SRS transmittable bands 400 are arranged on the same place in the system band among the plurality of communication terminals 2 that transmits the SRS in the uplink pilot time slot 352 of one special sub-frame 302. That is to say, the SRS transmittable bands 400 in the same band are set for the plurality of communication terminals 2 where the SRS is transmitted in the uplink pilot time slot 352 of one special sub-frame 302.

Further, in the communication system 100 according to this embodiment, a frequency band (referred to hereinafter as an “SRS transmission band”) used by one communication terminal 2 for single transmission of the SRS is allowed to be changed in each SRS transmission cycle 360 within the entire or partial range of the SRS transmittable band 400. Such control is referred to as “frequency hopping”. The bandwidth (referred to as hereinafter an “SRS transmission bandwidth”) of the SRS transmission band 450 is variable in this communication system 100.

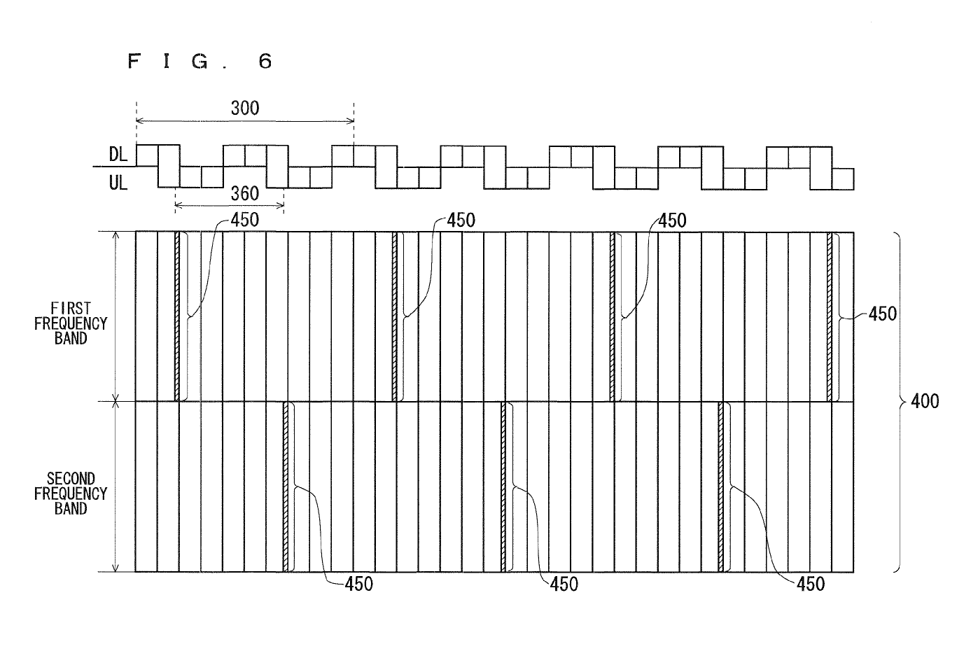

FIG. 6 is a diagram illustrating an example of the frequency hopping of the SRS transmission band 450 used by a certain communication terminal 2 within the entire range of the SRS transmittable band 400. Hereinafter, the communication terminal 2 being a target of the description is referred to as a “target communication terminal 2”. In the example of FIG. 6, the length of the SRS transmission cycle 360 for the target communication terminal 2 is set to 5 ms, and the SRS transmittable band 400 is divided into first and second frequency bands in the target communication terminal 2. The SRS transmission band 450 having a bandwidth which is one half of the bandwidth of the SRS transmittable band 400 is changed in each SRS transmission cycle 360 alternately between the first and second frequency bands.

The SRS transmission band 450 may be fixed to a constant frequency band without the frequency hopping. In other words, each of the communication terminals 2 is capable of cyclically transmitting the SRS having a constant transmission frequency band.

<Configuration of SRS>

In the communication system 100 according to the embodiment, two kinds of SRSs identified by a parameter k_{TC} called as “transmission Comb” are specified. Each of the communication terminals 2 transmits any one of the two kinds of SRSs by any one of the first uplink communication period for SRS 370a and the second uplink communication period for SRS 370b.

The parameter k_{TC} can take a value of “0” or “1”. A plurality of sub-carriers SC0 to be used for transmission of SRS (hereinafter referred to as “SRS0”) specified by the parameter k_{TC}=0 is arranged in the frequency direction not in a consecutive manner but in a comb-shaped manner. In other words, a carrier frequency of the SRS0 is arranged in a frequency direction in the comb-shaped manner. Similarly, a plurality of sub-carriers SC1 to be used for transmission of SRS (hereinafter referred to as “SRS1”) specified by the parameter k_{TC}=1 is arranged in the frequency direction in the comb-shaped manner. When the SRS0 and the SRS1 are transmitted at the same frequency bands, the plurality of sub-carriers SC0 to be used for the transmission of the SRS0 and the plurality of sub-carriers SC1 to be used for the transmission of the SRS1 are arranged alternately in the frequency direction. Therefore, the carrier frequency of the SRS0 and the carrier frequency of the SRS1 do not overlap with each other in the frequency direction.

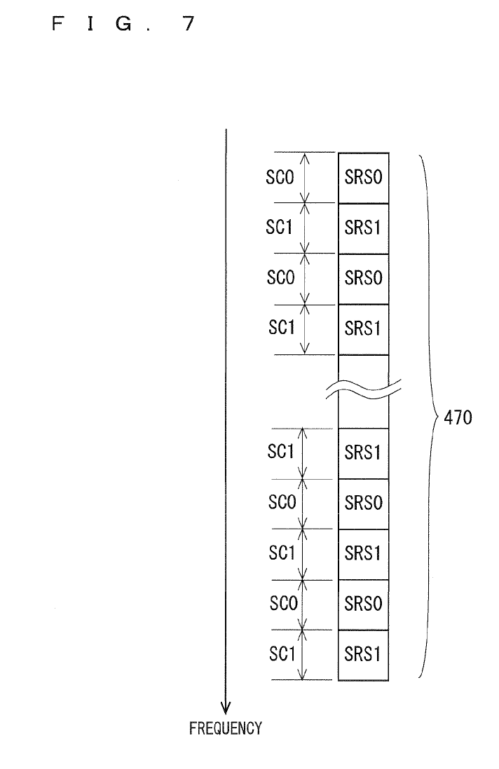

FIG. 7 illustrates transmission of both the SRS0 and SRS 1 in a certain frequency band 470. As shown in FIG. 7, the plurality of sub-carriers SC0 to be used for the transmission of the SRS0 is arranged in the frequency direction in every other sub-carrier. Similarly, the plurality of sub-carriers SC1 to be used for the transmission of the SRS1 is arranged in the frequency direction in every other sub-carrier. The plurality of sub-carriers SC0 and the plurality of sub-carriers SC1 included in the same frequency band 470 are arranged alternately in the frequency direction.

Since the plurality of sub-carriers to be used for the transmission of the SRS by one communication terminal 2 is arranged in the frequency direction in the comb-shaped manner, not all the sub-carriers in the SRS transmission band 450 to be used by the communication terminal 2 are used for the transmission of the SRS. Since the plurality of sub-carriers SC0 and the plurality of sub-carriers SC1 included in the same frequency band are arranged alternately, the communication terminal 2 that transmits the SRS0 and the communication terminal 2 that transmits the SRS1 can use the same SRS transmission band 450 in the same uplink communication period for SRS. When viewed from the side of the base station 1, the base station 1 can discriminate the SRS0 and the SRS1 transmitted in the SRS transmission band 450 for the same SRS uplink communication period from each other.

Further, in the communication system 100, eight types of code patterns composed of a plurality of SRS symbols composing the SRS are specified. The eight types of code patterns adopt eight types of code sequences that are orthogonal to each other. The communication terminals 2 transmit any one of the eight types of code patterns as the SRS.

Since the eight types of code patterns that adopt the eight types of code sequences orthogonal to each other are specified in the SRS, at most the eight communication terminals 2 can transmit the SRS0 in the same uplink communication period for SRS using the same SRS transmission band 450. Further, at most the eight communication terminals 2 can transmit the SRS1 in the same uplink communication period for SRS using the same SRS transmission band 450.

In this embodiment, each of the communication terminals 2 transmits the SRS0 in the first uplink communication period for SRS 370a, or transmits the SRS0 in the second uplink communication period for SRS 370b, or transmits the SRS1 in the second uplink communication period for SRS 370b. In the LTE, each of the communication terminals 2 is allowed to transmit the SRS1 in the first uplink communication period for SRS 370a, but in this embodiment, each of the communication terminals 2 does not transmit the SRS1 in the first uplink communication period for SRS 370a.

Hereinafter, an uplink radio resource, that is specified by the first uplink communication period for SRS 370a and the plurality of sub-carriers SC0 of the comb-shape capable of being used for the transmission of the SRS0 included in the frequency band of the special sub-frame 302, is referred to as a “first uplink radio resource for SRS 500a”. Further, an uplink radio resource, that is specified by the second uplink communication period for SRS 370b and the plurality of sub-carriers SC0 of the comb-shape capable of being used for the transmission of the SRS0 included in the frequency band of the special sub-frame 302, is referred to as a “second uplink radio resource for SRS 500b”. An uplink radio resource, that is specified by the second uplink communication period for SRS 370b and the plurality of sub-carriers SC1 of the comb-shape which is included in the frequency band of the special sub-frame 302 and is capable of transmitting the SRS1, is referred to as a “third uplink radio resource for SRS 500c”.

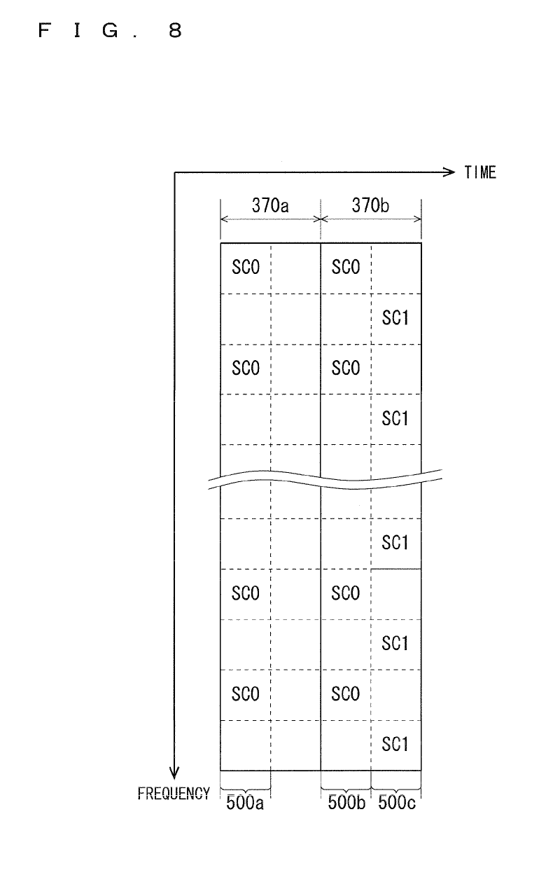

FIG. 8 is a diagram illustrating the first uplink radio resource for SRS 500a, the second uplink radio resource for SRS 500b and the third uplink radio resource for SRS 500c. As shown in FIG. 8, the first uplink radio resource for SRS 500a, the second uplink radio resource for SRS 500b and the third uplink radio resource for SRS 500c are different from each other at least any one of in the time direction and in the frequency direction. Hereinafter, these uplink radio resources are referred to as “uplink radio resources for SRS” unless otherwise discriminated.

In this embodiment, the transmission mode determining section 125 for determining the transmission mode of the SRS determines the uplink communication period for SRS, the SRS transmission bandwidth, a head position of the SRS transmission band 450, the SRS transmission cycle 360, a value of parameter k_{TC} and a type of the SRS code pattern to be used in each of the communication terminals 2 that communicates with the base station 1. As a result, the transmission mode determining section 125 determines any one of the uplink radio resource included in the first uplink radio resource for SRS 500a, the uplink radio resource included in the second uplink radio resource for SRS 500b and the uplink radio resource included in the third uplink radio resource for SRS 500c for the transmission of the SRS in each of the communication terminals 2 to communicate with the base station 1. When the head position of the SRS transmission band 450 changes at every SRS transmission cycle 360, the SRS transmission band 450 performs the frequency hopping. For this reason, the transmission mode determining section 125 determines the SRS transmission bandwidth and the head position of the SRS transmission band 450 in the communication terminal 2 so as to be capable of determining the SRS transmission band 450 of the communication terminal 2. Further, in LTE, a plurality of bandwidths that is different from each other is determined as bandwidths that can be set as the SRS transmission bandwidth. For example, when the system bandwidth is 10 MHz, three types of bandwidths including a bandwidth (180 kHz×40) for 40 resource blocks, a bandwidth (180 kHz×20) for 20 resource blocks, and a bandwidth (180 kHz×4) for 4 resource blocks are determined. The transmission mode determining section 125 determines one of the plurality of bandwidths as the SRS transmission bandwidth.

The transmission signal generating section 120 generates a transmission signal including control data (referred to as “SRS control data” hereinafter) for notifying a communication terminal 2 about the transmission mode of the SRS to be transmitted by the communication terminal 2 which is determined by the transmission mode determining section 125. This transmission signal is transmitted from the communication section 13 to the communication terminal 2 by using the downlink sub-frame 302. As a result, the SRS control data is transmitted to each communication terminal 2. This allows each communication terminal 2 to know the transmission mode of the SRS to be transmitted therefrom. That is to say, each of the communication terminals 2 can recognize a type of the code pattern of the SRS to be transmitted therefrom, an uplink radio resource to be used for the transmission of the SRS and the SRS transmission cycle 360. Each communication terminal 2 cyclically transmits the SRS based on the transmission mode determined by the base station 1.

It should be noted that the SRS control data includes transmission start data for providing an instruction to start the transmission of the SRS or transmission stop data for providing an instruction to stop the transmission of the SRS. Upon receipt of the SRS control data including the transmission start data, a communication terminal 2 which is not transmitting the SRS starts the cyclic transmission of the SRS based on the transmission mode about which an instruction is provided by the SRS control data.

Upon receipt of the SRS control data including the transmission stop data, the communication terminal 2 which is cyclically transmitting the SRS stops the transmission of the SRS. When changing the transmission mode of the SRS which the communication terminal 2 transmits, the communication terminal 2 is notified about the SRS control data for providing an instruction about a changed transmission mode. Such SRS control data is referred to as an “RRC Connection Reconfiguration message” in LTE.

<Basic Operation of Communication System in Controlling Transmission of SRS>

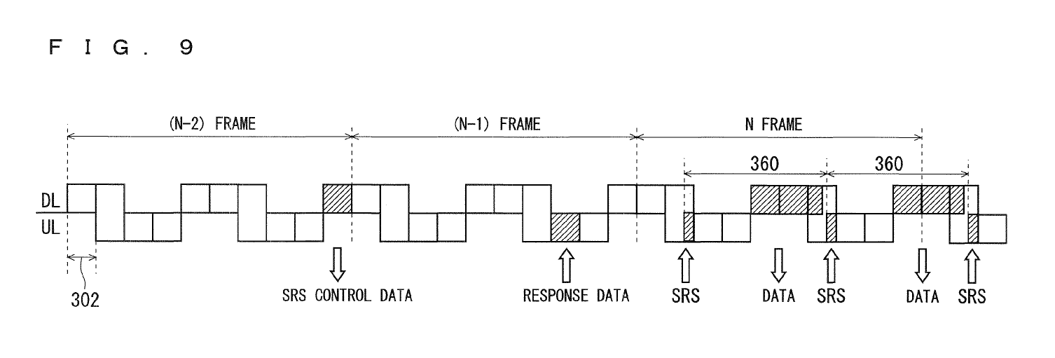

Description will be given on the operation of the communication system 100 after a target communication terminal 2 receives the SRS control data and until the target communication terminal 2 transmits the SRS, based on the transmission mode about which notification is provided by the SRS control data. FIG. 9 is a diagram illustrating the operation.

As shown in FIG. 9, after the transmission signal including the SRS control data is transmitted from the base station 1 to a target communication terminal 2 in the downlink sub-frame 302 positioned at the trailing end of the (N−2)th TDD frame 300, the target communication terminal 2 transmits the transmission signal including response data for notifying the base station 1 about normal reception of the SRS control data in the eighth uplink sub-frame 302 (the seventh sub-frame 302) from the leading end of the subsequent (N−1)th TDD frame 300. Such response data is referred to as an “RRC Connection Reconfiguration Complete message”.

After transmitting the response data, the target communication terminal 2 transmits the SRS in the transmission mode about which the instruction is provided by the received SRS control data in and after the subsequent Nth TDD frame 300. In the example of FIG. 9, the length of the SRS transmission cycle 360 is set to 5 ms.

In the example of FIG. 9, the target communication terminal 2 transmits the response data in the (N−1)th TDD frame 300, but the target communication terminal 2 transmits the response data in a TDD frame 300 subsequent to the (N−1)th TDD frame 300 in some cases.

When the communication terminal 2 which is transmitting the SRS receives the SRS control data for providing notification about a changed transmission mode, the target communication terminal 2 transmits the SRS in the current transmission mode until transmitting the SRS in the new transmission mode about which notification is provided by the SRS control data (in the example of FIG. 9, until the second special sub-frame 302 of the (N−1)th TDD frame 300).

In this manner, after the base station 1 transmits the SRS control data to the target communication terminal 2 in a certain TDD frame 300, the target communication terminal 2 transmits the SRS based on the SRS control data in and after a TDD frame 300 which is at least the next but one counting from the certain TDD frame 300. Thus, when the base station 1 instructs the target communication terminal 2 to start the transmission of the SRS or to change the transmission mode of the SRS, it takes a certain length of time between the transmission of the SRS control data to the target communication terminal 2 and the reception of the SRS transmitted from the target communication terminal 2 based on the SRS control data. The base station 1 transmits the SRS control data to a communication terminal 2 newly connected thereto or a communication terminal 2 that is connected thereto and starts data transmission, and instructs the communication terminals 2 to start transmission of the SRS. As a result, each of the communication terminals 2 which performs downlink communication of data with the base station 1 transmits the SRS to the base station 1. Hereinafter, the communication terminal 2 that is transmitting the SRS is referred to as a “communication target terminal 2” in some cases.

Also when the base station 1 instructs the communication terminal 2 which is cyclically transmitting the SRS to stop the transmission of the SRS, the communication system 100 similarly operates. For example, after the SRS control data including the transmission stopping data is transmitted from the base station 1 to the target communication terminal 2 in the downlink sub-frame 302 positioned in the trailing end of the (N−2)th TDD frame 300, the target communication terminal 2 transmits response data for notifying the base station 1 about normal reception of the SRS control data in the eighth uplink sub-frame 302 from the leading end of the subsequent (N−1)th TDD frame 300. After transmitting the response data, the target communication terminal 2 stops the transmission of the SRS in the subsequent Nth TDD frame 300.

In such a manner, when the base station 1 instructs the target communication terminals 2 to stop the transmission of the SRS, it take a certain length of time between the transmission of the SRS control data to the target communication terminal 2 and the stopping of the transmission of the SRS in the target communication terminal 2. The base station 1 transmits the SRS control data to a communication terminal 2 connected to the neighboring base station 1 by handover, or a communication terminal 2 that is connected thereto and completes the data transmission, and instructs the communication terminal 2 to stop the transmission of the SRS. As a result, each of the communication terminals 2 that does not have to perform the downlink communication of data with the base station 1 does not transmit the SRS to the base station 1.

<Association Between the SRS Upstream Radio Resource and the Downstream Radio Resource>

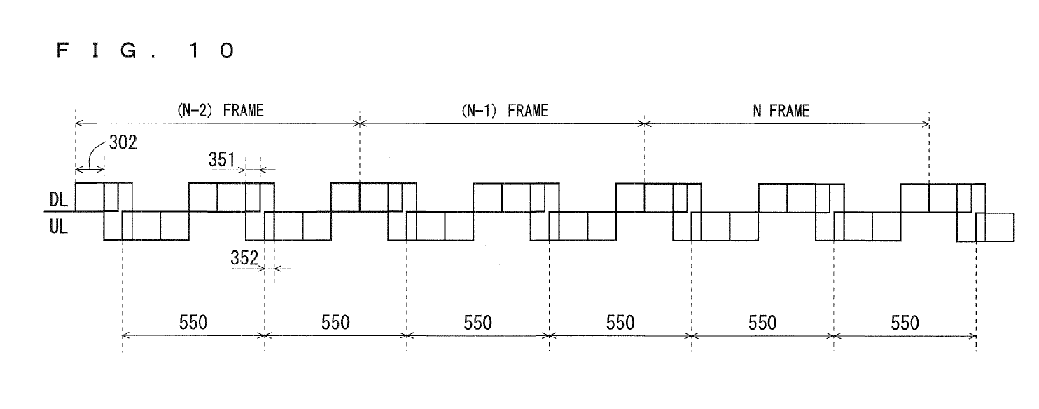

In this embodiment, as to a period 550 between the leading end of the uplink pilot time slot 352 of the special sub-frame 302 and the leading end of the uplink pilot time slot 352 of the subsequent special sub-frame 302 shown in FIG. 10, the first uplink radio resource for SRS 500a and the leading downlink sub-frame 302 included in the period 550 are associated with each other. Further, the second uplink radio resource for SRS 500b and the second downlink sub-frame 302 included in the period 550 are associated with each other. The third uplink radio resource for SRS 500c included in the period 550 and a portion including the downlink pilot time slot 351 in the special sub-frame 302 included in the period 550 are associated with each other.

Hereinafter, the period 550 is referred to as an “association unit period 550”. Further, as to the two downlink sub-frames 302 included in the association unit period 550, a leading one of the downlink sub-frame 302 is referred to as a “first downlink radio resource 560a”, and a trailing one of the downlink sub-frame 302 is referred to as a “second downlink radio resource 560b”. Further, a portion including the downlink pilot time slot 351 in the special sub-frame 302 included in the association unit period 550 is referred to as a “third downlink radio resource 560c”. The first downlink radio resource 560a, the second downlink radio resource 560b and the third downlink radio resource 560c are each referred to as a “downlink radio resources 560” unless otherwise discriminated.

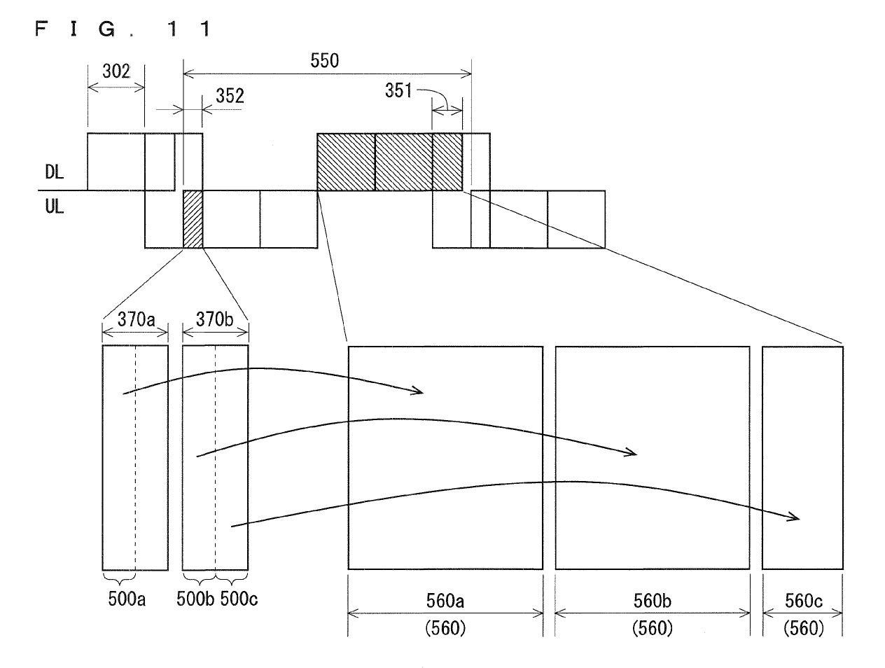

FIG. 11 is a diagram illustrating the association between the uplink radio resource for SRS and the downlink radio resource 560 in a certain association unit period 550. FIG. 11 illustrates the association unit period 550 including the uplink pilot time slot 352 of the first special sub-frame 302 in the TDD frame 300, but the same is true on the association unit period 550 including the uplink pilot time slot 352 of the second special sub-frame 302 in the TDD frame 300.

When the use downlink radio resources, which include in the frequency direction the frequency band included in the SRS transmission frequency band, are allocated to the communication terminals 2 that transmit the SRS using at least a part of the uplink radio resource for SRS at each of the association unit period 550, the scheduling executing section 122 determines the use downlink radio resources from the downlink radio resources 560 associated with the uplink radio resources for SRS.

Hereinafter, in the association unit period 550, the use downlink radio resources, that include in the frequency direction the frequency band included in the SRS transmission frequency band and are allocated from the downlink radio resources 560 associated with the uplink radio resource for SRS to the communication terminals 2 that transmit the SRS using at least a part of the uplink radio resource for SRS, are referred to as “associated downlink radio resources”. Further, a portion in the uplink radio resource for SRS, which is used for the transmission of the SRS by the communication terminal 2, is referred to as an “SRS use uplink radio resource” of the communication terminal 2. Further, a communication terminal 2 that transmits the SRS using the uplink radio resource for SRS included in the association unit period 550 in the communication terminals 2 for performing downlink communication in the association unit period 550 is referred to as an “SRS most recent transmission terminal 2”.

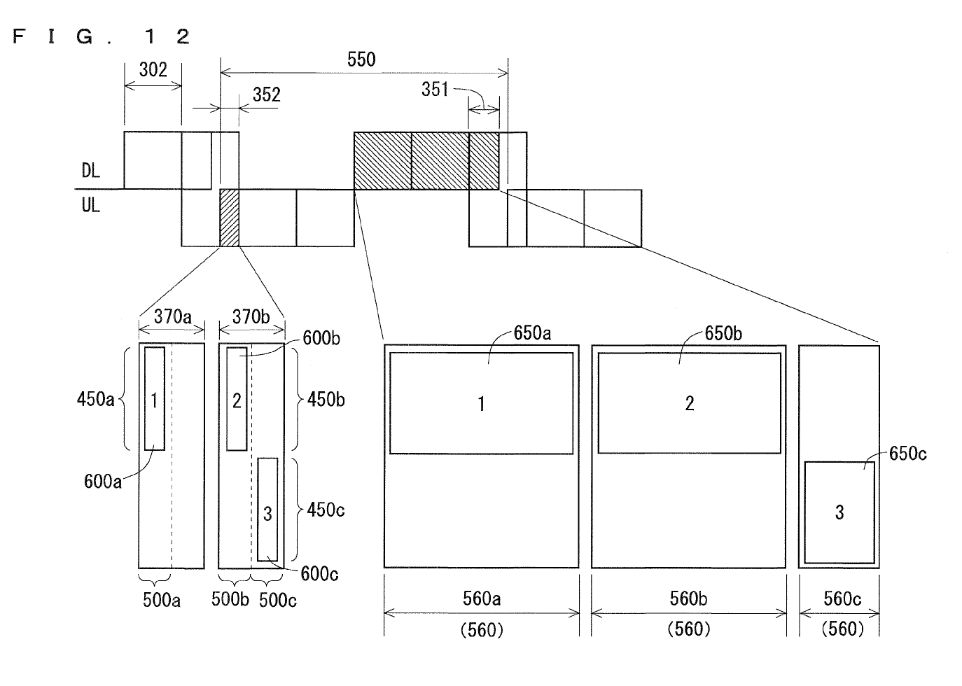

FIG. 12 is a diagram illustrating an allocation example of the associated downlink radio resources to the SRS most recent transmission terminals 2 of terminal numbers 1 to 3 for performing downlink communication with the base station 1 in a certain association unit period 550. The association unit period 550 being a target of description is hereinafter referred to as a “target association unit period 550”.

In the example shown in FIG. 12, the SRS most recent transmission terminal 2 of terminal number 1 transmits the SRS using a part of the first uplink radio resource for SRS 500a, and the SRS most recent transmission terminal 2 of terminal number 2 transmits the SRS using a part of the second uplink radio resource for SRS 500b, and the SRS most recent transmission terminal 2 of terminal number 3 transmits the SRS using a part of the third uplink radio resource for SRS 500c. In other words, the SRS use uplink radio resource 600a of the SRS most recent transmission terminal 2 of terminal number 1 is a part of the first uplink radio resource for SRS 500a, the SRS use uplink radio resource 600b of the SRS most recent transmission terminal 2 of terminal number 2 is a part of the second uplink radio resource for SRS 500b, and the SRS use uplink radio resource 600c of the SRS most recent transmission terminal 2 of terminal number 3 is a part of the third uplink radio resource for SRS 500c.

Further, in the example shown in FIG. 12, to the SRS most recent transmission terminal 2 of terminal number 1, an associated downlink radio resource 650a, which includes in the frequency direction a frequency band matching with the SRS transmission band 450a (the frequency band of the SRS use uplink radio resource 600a) of the SRS transmitted by the SRS most recent transmission terminal 2, is allocated from the first downlink radio resource 560a. To the SRS most recent transmission terminal 2 of terminal number 2, an associated downlink radio resource 650b, which includes in the frequency direction a frequency band matching with the SRS transmission band 450b (the frequency band of the SRS use uplink radio resource 600b) of the SRS transmitted by the SRS most recent transmission terminal 2, is allocated from the second downlink radio resource 560b. To the SRS most recent transmission terminal 2 of terminal number 3, an associated downlink radio resource 650c, which includes in the frequency direction a frequency band matching with the SRS transmission band 450c (the frequency band of the SRSSRS use uplink radio resource 600c) of the SRS transmitted by the SRS most recent transmission terminal 2, is allocated from the third downlink radio resource 560c.

In the example shown in FIG. 12, the associated downlink radio resource, which includes in the frequency direction the frequency band matching with the SRS transmission band 450 of the SRS transmitted by the SRS most recent transmission terminal 2, is allocated to the SRS most recent transmission terminal 2, but an associated downlink radio resource, which includes in the frequency direction a frequency band matching with a part of the SRS transmission band 450 may be allocated to the SRS most recent transmission terminal 2.

Further, in this embodiment, in the case where the scheduling executing section 122 allocates the associated downlink radio resource to the SRS most recent transmission terminal 2 for transmitting the SRS using at least a part of the uplink radio resource for SRS in the association unit period 550, at the time of making downlink communication with the SRS most recent transmission terminal 2 using the associated downlink radio resource, the communication section 13 controls array transmission based on a reception signal received in the frequency band of the associated downlink radio resource in the uplink radio resource for SRS. This reception signal includes SRS to be transmitted by the SRS most recent transmission terminal 2 as a desired wave component. Hereinafter, the array transmission control is referred to as a “first array transmission control”. Further, scheduling for allocating the associated downlink radio resource to the SRS most recent transmission terminal 2 that is the condition of making the first array transmission control is referred to as “associated scheduling”. The first array transmission control and the associated scheduling that form a pair are collectively referred to as a “first transmission control”. In this embodiment, as described later, the second transmission control different from the first transmission control is present. The first array transmission control will be described in detail below with reference to FIG. 12 by exemplifying the SRS most recent transmission terminal 2 of terminal number 1.

In the example of FIG. 12, when the communication section 13 transmits data to the SRS most recent transmission terminal 2 of terminal number 1 using the associated downlink radio resource 650a allocated thereto, a transmission weight is calculated based on a reception signal received in the frequency band of the associated downlink radio resource 650a in the first uplink radio resource for SRS 500a. In other words, when the communication section 13 transmits data to the SRS most recent transmission terminal 2 of terminal number 1 using the associated downlink radio resource 650a allocated thereto, a transmission weight is calculated based on a reception signal received in the frequency band matching with the frequency band of the associated downlink radio resource 650a in the SRS use uplink radio resource 600a. This reception signal includes SRS to be transmitted by the SRS most recent transmission terminal 2 of terminal number 1 using the SRS use uplink radio resource 600a as a desired wave component.

In the array transmission control according to this embodiment, null steering and beam forming are simultaneously carried out. In the communication section 13, the reception weight is updated by using a serially updating algorithm such as RLS (Recursive Least-Squares) algorithm a plurality of times, and a transmission weight is calculated based on a reception weight after completion of the updating so that both the null steering and the beam forming are carried out simultaneously.

The communication section 13 updates the reception weight a plurality of times based on a plurality of complex symbols composing a reception signal (more specifically, a synthesized reception signal obtained by the reception weight processing section 124 from the plurality of reception signals received by a plurality of antennas 110a in the frequency band) received by the SRS use uplink radio resource 600a of the SRS most recent transmission terminal 2 of terminal number 1 in the frequency band of the associated downlink radio resource 650a, and calculates a transmission weight based on the reception weight after the completion of updating. The communication section 13 sets the calculated transmission weight to a transmission signal including the control data and the user data transmitted by using the associated downlink radio resource 650a. In such a manner, the first array transmission control is performed on the SRS most recent transmission terminal 2.

In the array transmission control according to the embodiment, the transmission weight is determined, for example, for each frequency band of one resource block. Hereinafter, the frequency band of one resource block is referred to as “RB band”. For example, when the frequency band of the associated downlink radio resource 650a allocated to the SRS most recent transmission terminal 2 of terminal number 1 is composed of four RB bands, the four RB bands is obtained for each of the transmission weights in the first array transmission control of the SRS most recent transmission terminal 2. The transmission weight to be applied to the signal transmitted to the SRS most recent transmission terminal 2 of terminal number 1 by using a certain RB band included in the associated downlink radio resource 650a is calculated based on a updated reception weight which is obtained by updating the reception weight six times based on six complex symbols received in the certain RB bands in the plurality of complex symbols composing the reception signal received by the SRS use uplink radio resource 600a in frequency band of the associated downlink radio resource 650a. Twelve complex symbols are transmittable using one RB band because one resource block includes 12 sub-carriers. On the other hand, as described above, the plurality of sub-carriers used for transmission of SRS by one communication terminal 2 is arranged in the frequency direction in the comb-shaped manner. The reception weight processing section 124 updates the reception weight six times using six complex symbols corresponding to six sub-carries used for the transmission of the SRS by the SRS most recent transmission terminal 2 of terminal number 1 in twelve complex symbols received in a certain RB band included in the frequency band of the associated downlink radio resource 650a in the SRS use uplink radio resource 600a.

When the downlink communication with the SRS most recent transmission terminal 2 being a target of communication is performed, the first transmission control in each of the base stations 1 enables a beam relating to the transmission directivity of the array antenna 110 to direct at the SRS most recent transmission terminal 2, and enables a null relating to the transmission directivity of the array antenna 110 to direct at the communication terminals 2 with which the neighboring base station 1 communicates using the downlink radio resource that is the same as the downlink radio resource used for the downlink communication. As a result, each of the base stations 1 can securely send signals to the SRS most recent transmission terminal 2 in each of the association unit periods 550, and can repress interference to the communication terminals 2 that communicate with the neighboring base station 1. This point is described in detail below.

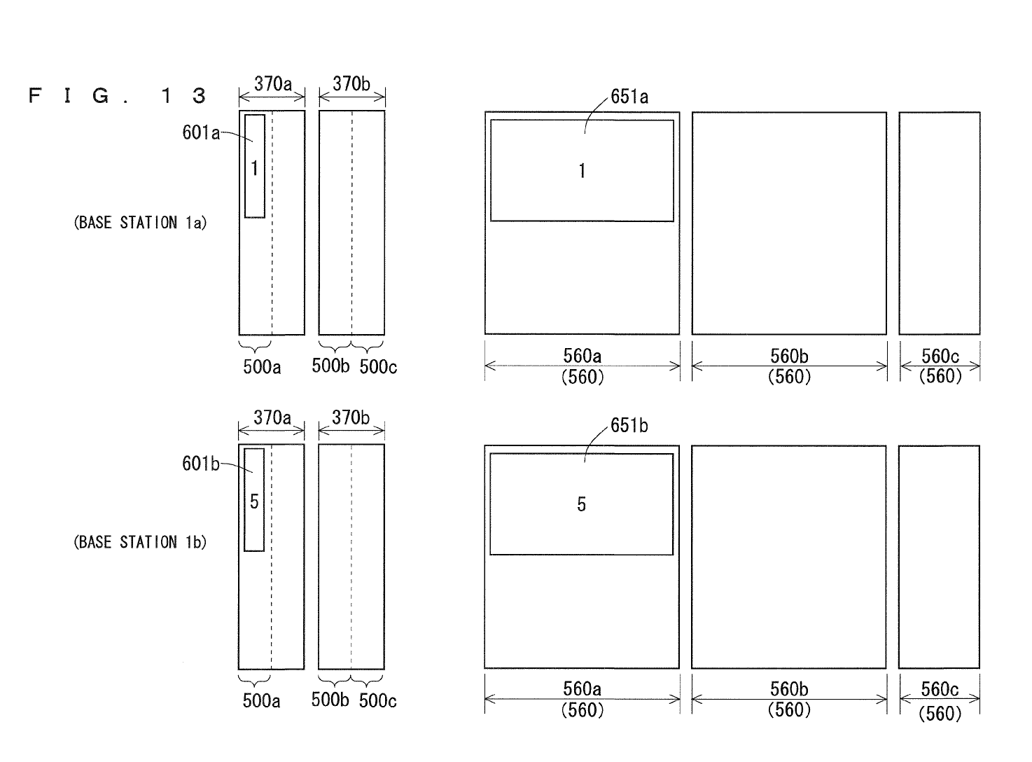

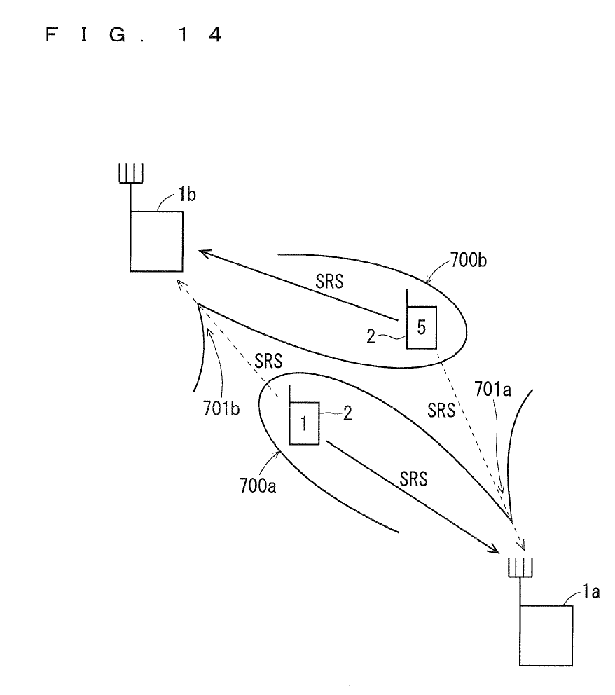

FIGS. 13 and 14 are diagrams describing advantages of the first transmission control. FIG. 13 illustrates the SRS use uplink radio resource and the associated downlink radio resources relating to the two base stations 1a and 1b in the target association unit period 550. Further, FIG. 14 illustrates the beam and null relating to transmission directivity of the base stations 1a and 1b in the target association unit period 550.

In examples of FIGS. 13 and 14, the base station 1a performs the first transmission control in the target association unit period 550, and makes downlink communication with the communication terminal 2 of terminal number 1 as the SRS most recent transmission terminal 2. The base station 1b makes the first transmission control, and makes downlink communication with the communication terminal 2 of terminal number 5 as the SRS most recent transmission terminal 2. In the example of FIGS. 13 and 14, an SRS use uplink radio resource 601a of the communication terminal 2 of terminal number 1 matches with an SRS use uplink radio resource 601b of the communication terminal 2 of terminal number 5, and a part of the first uplink radio resource for SRS 500a is the SRS use uplink radio resources 601a and 601b. In the example of FIGS. 13 and 14, a frequency band of the associated downlink radio resource 651a allocated to the communication terminals 2 of terminal number 1 matches with a frequency band of the SRS use uplink radio resource 601a. A frequency band of the associated downlink radio resources 651b allocated to the communication terminal 2 of terminal number 5 matches with a frequency band of the SRS use uplink radio resource 601b.

In the example of FIGS. 13 and 14, since the SRS use uplink radio resource 601a of the communication terminal 2 of terminal number 1 matches with the SRS use uplink radio resource 601b of the communication terminal 2 of terminal number 5, a reception signal received by the base station 1a in the SRS use uplink radio resource 601a includes the SRS to be transmitted by the communication terminal 2 of terminal number 1 as a desired wave component, and includes the SRS transmitted by the communication terminal 2 of terminal number 5 with which the base station 1b positioned around the base station 1a communicates as an interference wave component. Therefore, when the base station 1a calculates the transmission weight based on the reception signal and sets the transmission weight to the transmission signal to be transmitted to the communication terminal 2 of terminal number 1 using the associated downlink radio resource 651a, as shown in FIG. 14, in the transmission directivity of the array antenna 110 at the transmission by the base station 1a using the associated downlink radio resource 651a, a beam 700a directs at the communication terminal 2 of terminal number 1 and a null 701a directs at the communication terminal 2 of terminal number 5 that communicates with the base station 1b. The base station 1a, therefore, can securely send a transmission signal to the communication terminal 2 being a target of communication, and can repress the interference to the communication terminal 2 with which the neighboring base station 1b communicates. From the side of the base station 1b, when the neighboring base station 1a communicates with the communication terminal 2, the null directs at the communication terminal 2 with which the base station 1b communicates.

On the other hand, the reception signal that is received by the base station 1b through the SRS use uplink radio resource 601b includes the SRS to be transmitted by the communication terminal 2 of terminal number 5 as a desired wave component, and includes the SRS to be transmitted by the communication terminal 2 of terminal number 1 communicating with the base station 1a around the base station 1b as an interference wave component. Therefore, when the base station 1b calculates a transmission weight based on the reception signal, and sets the transmission weight to a transmission signal to be transmitted to the communication terminal 2 of terminal number 5 using the associated downlink radio resources 651b, as shown in FIG. 14, in the transmission directivity of the array antenna 110 at time when the base station 1b transmits the transmission signal using the associated downlink radio resource 651b, a beam 700b directs at the communication terminal 2 of terminal number 5, and a null 701b directs at the communication terminal 2 of terminal number 1 communicating with the base station 1a. Therefore, the base station 1b can securely send a transmission signal to the communication terminal 2 being a target of the communication, and can repress the interference to the communication terminal 2 communicating with the neighboring base station 1a.

In the first transmission control, the beam can be directed at the communication terminal 2 being a target of communication, and the null can be directed at the communication terminal 2 being a non-target of communication. For this reason, this technique is effective in that the beam and the null can be suitably controlled. On the other hand, the first transmission control is disadvantageous from a viewpoint an improvement of a transmission throughput of the base station 1. This point is described below.

As described above, in the first transmission control in the target association unit period 550, as shown in FIG. 12, only a frequency band a included in a transmission frequency band of the SRS received in the target association unit period 550 can be used for the downlink communication. Further, in the first transmission control in the target association unit period 550, the use downlink radio resource can be allocated to the communication terminal 2 to which the SRS is transmitted through the uplink radio resource for SRS in the target association unit period 550 only from the downlink radio resource 560 corresponding to the uplink radio resource for SRS.

In the first transmission control, since scheduling for allocating the downlink radio resource to the communication terminal 2 in the frequency direction and the time direction is restricted, the downlink radio resource cannot be effectively used.

Particularly as shown in FIG. 12, when the number of the communication terminals 2 for transmitting the SRS in the target association unit period 550 is small, in the target association unit period 550, in all the downlink radio resources capable of being used for downlink communication, namely, in the downlink radio resources composed of the first downlink radio resource 560a, the second downlink radio resource 560b and the third downlink radio resource 560c, free downlink radio resources that are not used for the downlink communication increase. Even when the downlink communication with the communication terminals 2 for transmitting the SRS should be performed in an association unit period 550 different from the target association unit period 550, the free downlink radio resources cannot be used in the target association unit period 550. For this reason, it is difficult to improve the transmission throughput of the base station 1.

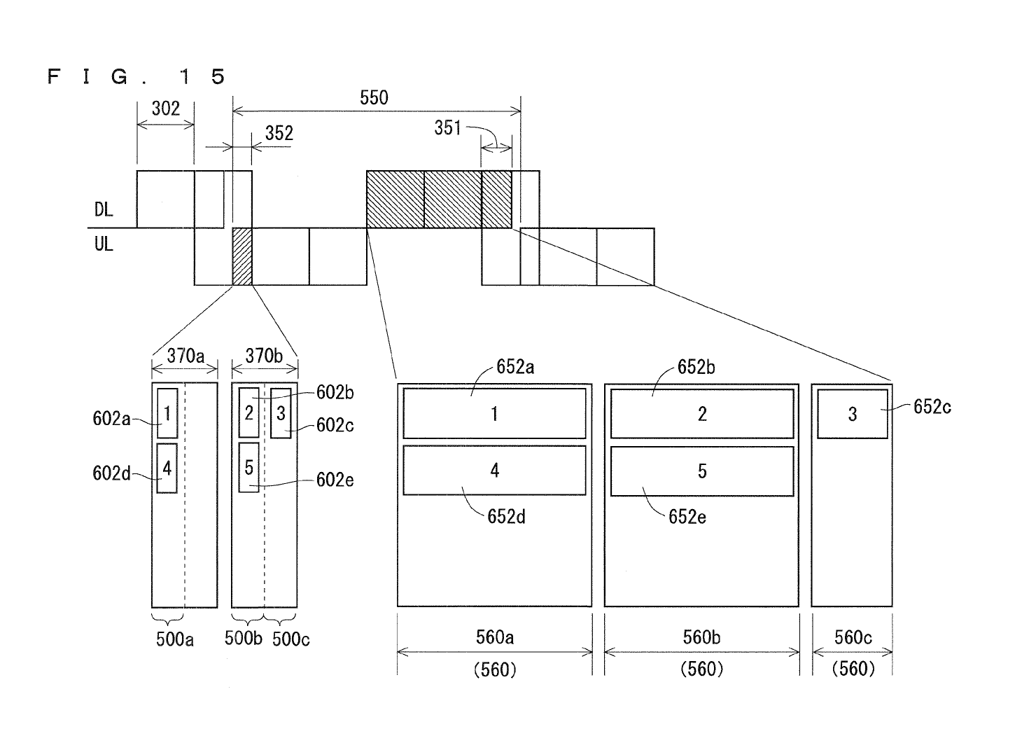

Further, as shown in FIG. 15, also when the transmission bandwidth (the SRS transmission bandwidth) of each SRS received in the target association unit period 550 is small, the free downlink radio resources increase in the target association unit period 550. For this reason, it is difficult to improve the transmission throughput of the base station 1. The example of FIG. 15 illustrates the SRS use uplink radio resources 602a to 602e of the communication terminals 2 of terminal numbers 1 to 5, and the associated downlink radio resources 652a to 652e allocated to the communication terminals 2 of terminal numbers 1 to 5.

In the base station 1 according to this embodiment, when the state of communication with the communication terminal 2 is bad due to a long distance with respect to the communication terminal 2, the SRS transmission bandwidth of the communication terminal 2 is small. As a result, the communication terminal 2 can concentrate electricity at time of transmission of the SRS, and the base station 1 is made to easily receive the SRS from the communication terminal 2. For example, the transmission mode determining section 125 of the base station 1 calculates a reception level of the reception signal from the communication terminal 2, and when the reception level is smaller than a threshold, the communication state between the communication terminals 2 and the base station 1 is determined as being bad. For the communication terminal 2, the smallest bandwidth of the plural types of bandwidths capable of being set as the SRS transmission bandwidth is set as the SRS transmission bandwidth of the communication terminal 2.

In such a manner, by the use of the first transmission control alone, it is difficult to improve the transmission throughput of the base station 1.

In the base station 1 according to this embodiment, therefore, the array transmission control is performed, and simultaneously the second transmission control, in which the downlink radio resources that cannot be used in the first transmission control are used for the downlink communication with the communication terminals 2, is made. As a result, while the array transmission control is being performed, the transmission throughput of the base station 1 can be improved. The second transmission control is described in detail below.

<The Second Transmission Control>

### <Scheduling in the Second Transmission Control>

In the second transmission control according to this embodiment, the scheduling executing section 122 of the base station 1 allocates the use downlink radio resource, which includes in the frequency direction the frequency band in which the SRS is not received in each of the uplink radio resource for SRS of the association unit period 550, from the downlink radio resource 560 associated with the uplink radio resource for SRS to the communication target terminal 2, namely, the communication terminal 2 transmitting the SRS. A scheduling for allocating the use downlink radio resource is hereinafter referred to as a “non-associated scheduling”. Further, a use downlink radio resource, which includes in the frequency direction the frequency band in which the base station 1 does not receive the SRS in the uplink radio resource for SRS and is selected from the downlink radio resources 560 associated with the uplink radio resources for SRS, is referred to as a “non-associated downlink radio resource”.

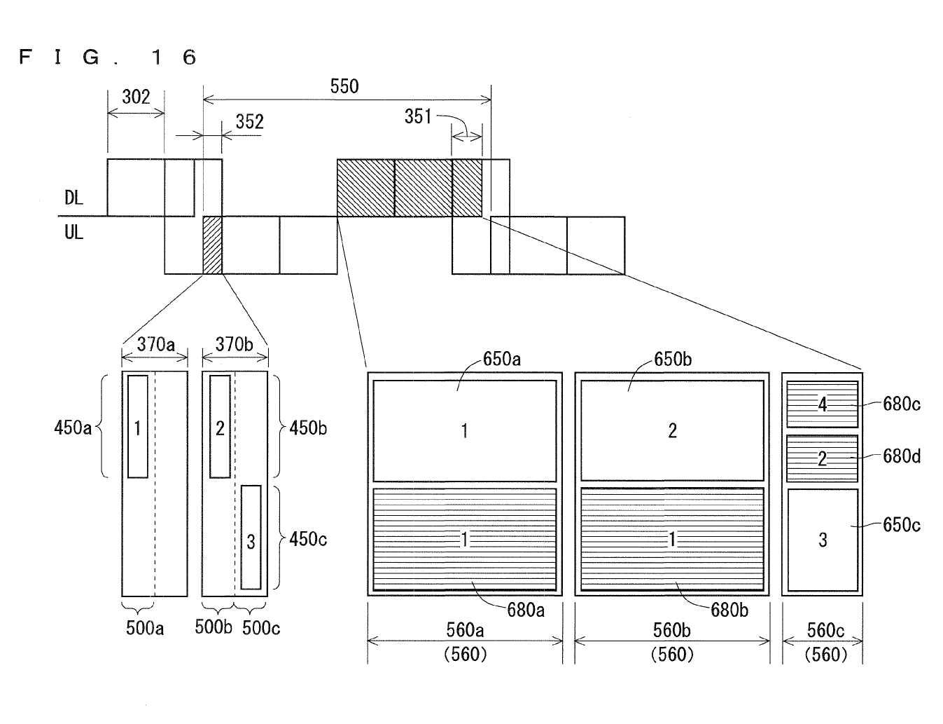

FIG. 16 is a diagram illustrating an example of allocation of the non-associated downlink radio resources to the communication terminals at time of performing the non-associated scheduling in the example of FIG. 12. In the example of FIG. 16, the non-associated downlink radio resource 680a, which includes in the frequency direction the frequency bands in which the SRS is not received in the first uplink radio resource for SRS 500a, namely, the frequency bands other than the SRS transmission band 450a of the communication terminal 2 of terminal number 1 and is selected from the first downlink radio resources 560a associated with the first uplink radio resources for SRS 500a, is allocated to the communication terminal 2 of terminal number 1.

Further, the non-associated downlink radio resource 680b, which includes in the frequency direction a frequency band in which the SRS is not received in the second uplink radio resource for SRS 500b, namely, the frequency bands other than the SRS transmission band 450b of the communication terminal 2 of terminal number 2 and is selected from the second downlink radio resources 560b associate with the second uplink radio resources for SRS 500b, is allocated to the communication terminal 2 of terminal number 1.

Further, the non-associated downlink radio resources 680c and 680d, which include in the frequency direction the frequency band in which the SRS is not received in the third uplink radio resource for SRS 500c, namely, the frequency bands other than the SRS transmission band 450c of the communication terminal 2 of terminal number 3 and is selected from the third downlink radio resources 560c associated with the third uplink radio resources for SRS 500c, are allocated to the communication terminals 2 of terminal numbers 4 and 2. The communication terminal 2 of terminal number 4 is the communication terminal 2 that transmits the SRS but does not transmit the SRS in the association unit period 550 shown in FIG. 16.

In the second transmission control according to the embodiment, the non-associated downlink radio resource is allocated to the communication terminal 2 in the association unit period 550 in, for example, each RB band (the frequency band in each resource block). That is to say, when the non-associated downlink radio resource is allocated to the communication terminal 2, the communication terminal 2 to which the use downlink radio resource including the RB band in the frequency direction is determined for each RB band.

<Array Transmission Control in Second Transmission Control>

In the second transmission control, when performing the downlink communication with the target communication terminal 2 using the non-associated downlink radio resource allocated to the target communication terminal 2 in the scheduling executing section 122, the communication section 13 generates the SRS received from the target communication terminal 2 in the frequency band of the non-associated downlink radio resource in a pseudo manner. The pseudo SRS is referred to as a “pseudo reception SRS”. The communication section 13 adds the generated pseudo reception SRS as a desired wave component to a reception signal received in the frequency band of the non-associated downlink radio resource in the uplink radio resource for SRS corresponding to the downlink radio resource 560 to which the non-associated downlink radio resource belongs. The communication section 13 makes the array transmission control based on a new reception signal (hereinafter referred to as “pseudo desired wave-containing reception signal”) obtained by this addition. The array transmission control is hereinafter referred to as “second array transmission control”.

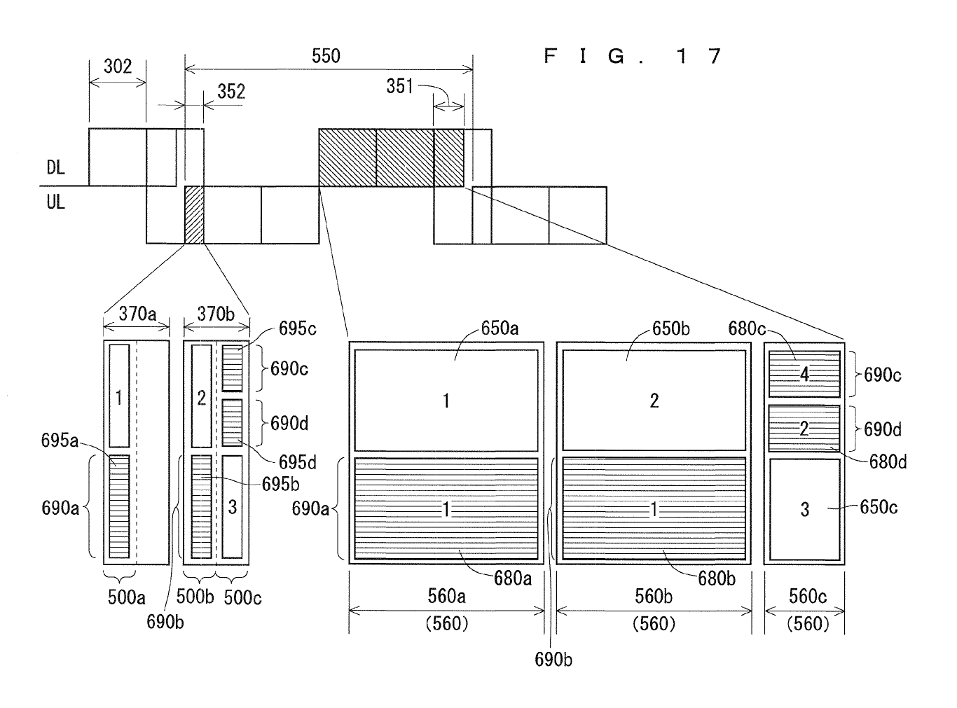

FIG. 17 is a diagram describing the second array transmission control in the example of FIG. 16. As shown in FIG. 17, in the scheduling executing section 122, when the non-associated downlink radio resource 680a included in the first downlink radio resource 560a is allocated to the communication terminal 2 of terminal number 1, the reception weight processing section 124 of the communication section 13 generates the SRS received from the communication terminal 2 of terminal number 1 in frequency band 690a of the non-associated downlink radio resource 680a in a pseudo manner. The reception weight processing section 124 adds the generated pseudo SRS as a desired wave component to a reception signal 695a received in the frequency band 690a of the non-associated downlink radio resource 680a in the first uplink radio resource for SRS 500a corresponding to the first downlink radio resource 560a to which the non-associated downlink radio resource 680a belongs, so as to generate a pseudo desired wave-containing reception signal. Thereafter, the reception weight processing section 124 updates the reception weight plural of times based on a plurality of complex symbols included in the generated pseudo desired wave-containing reception signal, and the transmission weight processing section 123 calculates the transmission weight based on the updated reception weight. The transmission weight processing section 123 sets the calculated transmission weight to the transmission signal to be transmitted by using the non-associated downlink radio resource 680a.

Further, in the scheduling executing section 122, when the non-associated downlink radio resource 680b included in the second downlink radio resource 560b is allocated to the communication terminal 2 of terminal number 1, the reception weight processing section 124 generates the SRS received from the communication terminal 2 of terminal number 1 in the frequency band 690b of the non-associated downlink radio resource 680b in a pseudo manner. The reception weight processing section 124 adds the generated pseudo SRS as a desired wave component to a reception signal 695b received in the frequency band 690b of the non-associated downlink radio resource 680b in the second uplink radio resource for SRS 500b, and generates a pseudo desired wave-containing reception signal. Thereafter, the communication section 13, similarly to the above, generates a transmission weight based on the generated pseudo desired wave-containing reception signal, and sets the transmission weight to a transmission signal to be transmitted by using the non-associated downlink radio resource 680b.

Further, in the scheduling executing section 122, when the non-associated downlink radio resource 680c included in the third downlink radio resource 560c is allocated to the communication terminal 2 of terminal number 4, the reception weight processing section 124 generates the SRS received from the communication terminal 2 of terminal number 4 in the frequency band 690c of the non-associated downlink radio resource 680c in a pseudo manner. The reception weight processing section 124 adds the generated pseudo SRS as a desired wave component to a reception signal 695c received in the frequency band 690c of the non-associated downlink radio resource 680c in the third uplink radio resource for SRS 500c, and generates a pseudo desired wave-containing reception signal. Thereafter, the communication section 13, similarly to the above, generates a transmission weight based on the generated pseudo desired wave-containing reception signal, and sets the transmission weight to a transmission signal to be received by using the non-associated downlink radio resource 680c.

Further, in the scheduling executing section 122, when the non-associated downlink radio resource 680d included in the third downlink radio resource 560c is allocated to the communication terminal 2 of terminal number 2, the reception weight processing section 124 generates the SRS to be received from the communication terminal 2 of terminal number 2 in the frequency band 690d in the non-associated downlink radio resource 680d in a pseudo manner. The reception weight processing section 124 adds the generated pseudo SRS as a desired wave component to a reception signal 695d to be received in a frequency band 690d of the non-associated downlink radio resource 680d in the third uplink radio resource for SRS 500c, and generates a pseudo desired wave-containing reception signal. Thereafter, the communication section 13, similarly to the above, generates a transmission weight based on the generated pseudo desired wave-containing reception signal, and sets the transmission weight to a transmission signal to be transmitted by using the non-associated downlink radio resource 680d.

In the second array transmission control in the second transmission control, when the downlink communication with the target communication terminal 2 is performed by using the non-associated downlink radio resource, the SRS received in the frequency band of the non-associated downlink radio resource is generated in a pseudo manner, and the array transmission control is performed based on the pseudo desired wave-containing reception signal including the pseudo SRS as a desired wave component. For this reason, the beam relating to the transmission directivity of the array antenna 110 can be directed at the target communication terminal 2.

On the contrary, assume that when the downlink communication with the target communication terminal 2 is performed by using the non-associated downlink radio resource, in the uplink radio resource for SRS corresponding to the downlink radio resource 560 to which the non-associated downlink radio resource belongs, the array transmission control is performed based on only reception signals (in the example of FIG. 17, reception signals 695a to 695d) to be received in the frequency band of the non-associated downlink radio resource. In this case, the beam is not likely to direct at the target communication terminal 2 because the reception signal does not include the SRS from the communication terminal 2 as a desired wave component. In this case, therefore, the transmission signal to be transmitted by using the non-associated downlink radio resource is not likely to reach the target communication terminal 2.

In the second array transmission control according to this embodiment, when the transmission signal is transmitted to the target communication terminal 2 by using the non-associated downlink radio resource, the array transmission control is performed based on the pseudo desired wave-containing reception signal including a pseudo signal of SRS to be received from the target communication terminal 2 in the frequency band of the non-associated downlink radio resource. For this reason, the beam can be directed at the target communication terminal 2. Therefore, the transmission signal to be transmitting by using the non-associated downlink radio resource can securely be sent to the target communication terminal 2.

Further, when the base station 1 makes the second transmission control and performs the downlink communication with the communication terminal 2, the neighboring base station 1 makes the first transmission control and can direct the null relating to the transmission directivity at the communication terminals 2 that performs the downlink communication. This point is described below.

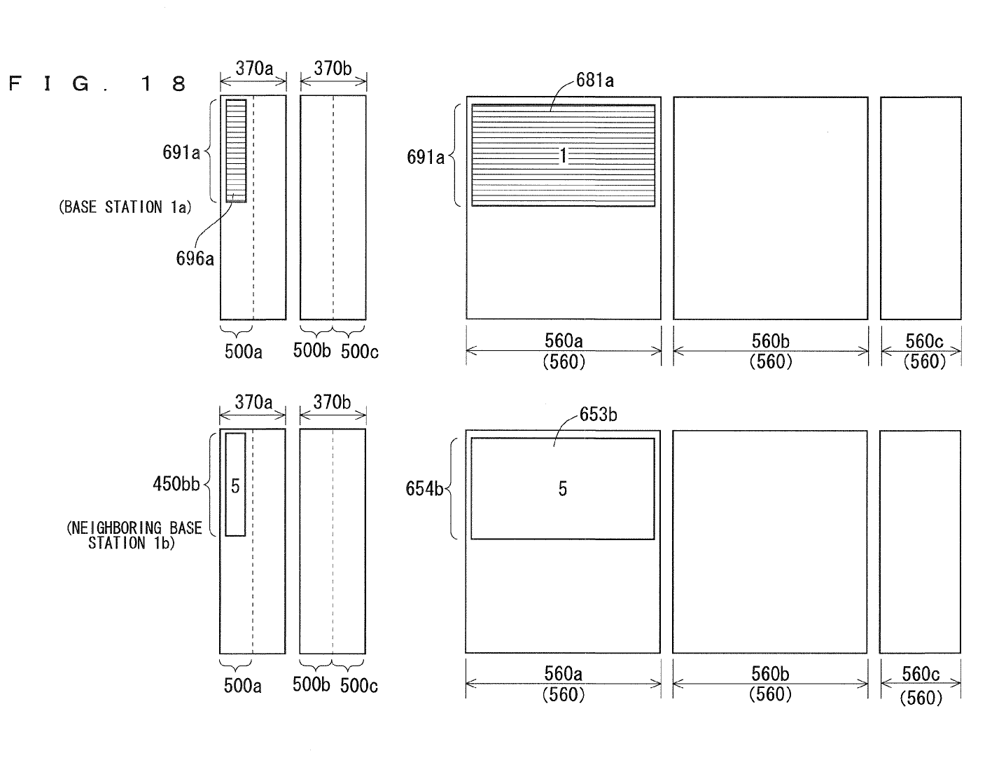

FIG. 18 is a diagram describing an example of the transmission control in the base station 1a and the neighboring base station 1b positioned therearound. In the example of FIG. 18, the base station 1a performs downlink communication with the communication terminal 2 of terminal number 1 using the second transmission control, and the neighboring base station 1b performs the downlink communication with the communication terminal 2 of terminal number 5 using the first transmission control. In the example of FIG. 18, the base station 1a allocates the non-associated downlink radio resource 681a included in the first downlink radio resource 560a to the communication terminal 2 of terminal number 1, and the neighboring base station 1b allocates the associated downlink radio resource 653b included in the first downlink radio resource 560a to the communication terminal 2 of terminal number 5. In the example of FIG. 18, the non-associated downlink radio resource 681a and the associated downlink radio resource 653b are set to the same frequency band and the same time zone. Therefore, in a case where the base station 1a does not make the array transmission control in the downlink communication with the communication terminal 2 of terminal number 1, when the communication terminal 2 of terminal number 5 that communicates with the neighboring base station 1b receives a transmission signal from the neighboring base station 1b, the transmission signal that is transmitted by the base station 1a to the communication terminal 2 of terminal number 1 is received as an interference wave.

In such a case, when the base station 1a makes the second array transmission control on the communication terminal 2 of terminal number 1, a reception signal 696a that is received in a frequency band 691a of the non-associated downlink radio resource 681a is used in the first transmission uplink radio resource for SRS 500a corresponding to the first downlink radio resource 560a to which the non-associated downlink radio resource 681a allocated to the communication terminal 2 of terminal number 1 belongs.

On the other hand, the neighboring base station 1b performs the downlink communication with the communication terminal 2 of terminal number 5 using the first transmission control, the communication terminal 2 of terminal number 5 transmits the SRS, where the frequency band including a frequency band 654b of a associated downlink radio resources 653a is a SRS transmission band 450bb, in the first uplink radio resource for SRS 500a corresponding to the first downlink radio resource 560a to which the associated downlink radio resource 653a belongs. Since the frequency band 691a of the non-associated downlink radio resource 681a matches with the frequency band 654b of the associated downlink radio resource 653a included in the SRS transmission band 450bb, the base station 1a receives a reception signal 696a in the frequency band 691a included in the SRS transmission band 450bb of the SRS in the first uplink radio resource for SRS 500a to be used when the communication terminal 2 of terminal number 5 transmits the SRS. The reception signal 696a to be used for the second array transmission control in the base station 1a, therefore, includes the SRS to be transmitted by the communication terminal 2 of terminal number 5 communicating with the neighboring base station 1b as an interference wave component. The base station 1a, therefore, makes the array transmission control based on the reception signal 696a to which the pseudo reception SRS is added, so that the neighboring base station 1b can direct the null at the communication terminal 2 of terminal number 5 using the first transmission control. As a result, a situation can be repress that when the communication terminal 2 of terminal number 5 receives a transmission signal from the neighboring base station 1b, the transmission signal transmitted to the communication terminal 2 of terminal number 1 by the base station 1a is received as an interference wave.

The base station 1 that makes the second transmission control can direct the beam at the communication terminals 2 being a target of communication, and the neighboring base station 1 can direct the null at the communication terminal 2 that performs the downlink communication using the first transmission control.

In the example of FIG. 18, when the neighboring base station 1b performs the downlink communication with the communication terminal 2 of terminal number 5 using the second transmission control, and when the downlink radio resource on the same position as the associated downlink radio resource 653b shown in FIG. 18 is allocated as the non-associated downlink radio resource to the communication terminal 2, the communication terminal 2 does not transmit the SRS in the first transmission uplink radio resource for SRS 500a. Therefore, the reception signal 696a to be received by the base station 1a in the first transmission uplink radio resource for SRS 500a does not include the SRS to be transmitted by the communication terminal 2 of terminal number 5 as the interference wave component. In this case, therefore, in the base station 1a, the null may be accidentally directed at the communication terminal 2 of terminal number 5 communicating with the neighboring base station 1b, but the null cannot be intentionally directed. Therefore, when the communication terminal 2 of terminal number 5 receives a transmission signal from the neighboring base station 1b, the transmission signal to be transmitted to the communication terminal 2 of terminal number 1 by the base station 1a is likely to be received as an interference wave.

<Method for Generating Pseudo Reception SRS>

In this embodiment, the pseudo reception SRS to be used in the second array transmission control on the target communication terminal 2 in the target association unit period 550 is generated based on an array response vector of a desired wave component obtained based on a reception signal including the SRS to be transmitted by the target communication terminal 2 before the target association unit period 550 as a desired wave component. A method for generating the pseudo reception SRS is described in detail below. A method for calculating the array response vector of the target communication terminal 2 is described first.

A reception signal vector X, which is composed of a reception signal for one sub-carrier including the SRS to be transmitted by the target communication terminal 2 as a desired wave component, which is received by the plurality of antennas 110a composing the array antenna 110, is expressed by the following formula (1).

[Mathematical Formula 1]

X=hₜ×S+h₁×U₁+h₂×U₂+ . . . h_{M}×U_{M}+N (1)

S represents a signal vector of a desired wave component composed of the SRS (SRS symbol) for one sub-carrier to be transmitted by the target communication terminal 2 which is received by the plurality of antennas 110a. U₁ (1≦1≦M) represents a signal vector of the interference wave component composed of the SRS (SRS symbol) for one sub-carrier to be transmitted by the communication terminal 2 communicating with the neighboring base station 1 which is received by the plurality of antennas 110a. Further, N represents a signal vector of the internal noise component. Further, hₜ represents an array response vector of the desired wave component, and h₁ represents an array response vector of the interference wave component.

The reception weight processing section 124 of the base station 1 calculates a correlation value between the reception signal vector X per one sub-carrier and the known signal vector of the desired wave component obtained from an output signal from the radio processing section 11. The reception weight processing section 124 calculates the correlation value for each of six sub-carriers to be used for the transmission of SRS included in one RB band. The reception weight processing section 124 calculates an average value of the obtained six correlation values. This average value is referred to as a “correlation average value”.

Since frequencies of twelve sub-carriers included in one RB band are adjacent to each other, response vectors hₜ, h₁ of six of the twelve sub-carriers to be used for the transmission of SRS in the reception signal vector X are considered to be the same as each other. Further, in LTE, a correlation between the SRS to be transmitted by the communication terminal 2 communicating with the base station 1 and the SRS to be transmitted by the communication terminal 2 communicating with the neighboring base station 1 is low. For this reason, a correlation between a signal vector U₁ of the interference wave component and the signal vector S of the desired wave component is low. Further, a correlation between the signal vector N of the internal noise component and the signal vector S of the desired wave component is also low. The correlation value between the signal vector S of the desired wave component and the signal vector S of the desired wave component is such that all the vector elements are “1”. The correlation average value is, therefore, equal to the array response vector hₜ. In such a manner, the reception weight processing section 124 calculates the array response vector hₜ of one RB band. The reception weight processing section 124 calculates the array response vector hₜ of all the RB bands included in all the frequency bands in which each of the communication terminals 2 that transmits the SRS, namely, all the RB bands included in frequency bands in which the SRS transmission band 450 of the communication terminals 2 performs frequency hopping for one cycle.

In LTE, the communication terminals 2 cannot occasionally transmit the SRS over all the regions of the system band according to a width of the system band and the mode of frequency hopping. In this case, the array response vector hₜ of the frequency band in which the communication terminals 2 do not transmit the SRS cannot be calculated.

Every time when the target communication terminal 2 transmits the SRS with the SRS transmission cycle 360, the reception weight processing section 124 calculates the array response vector hₜ of the target communication terminals 2. The reception weight processing section 124 calculates the array response vector hₜ of each the RB bands included in the frequency band (the SRS transmission bands 450 of the SRS) of a reception signal based on the reception signal which is received by the communication section 13 in the SRS use uplink radio resource used by the target communication terminal 2 for the transmission of the SRS and includes the SRS as a desired wave component. When the array response vector ht of the same RB bands is already present as the newly obtained array response vector hₜ, the reception weight processing section 124 stores the newly calculated array response vector hₜ instead of the old array response vector hₜ. In such a manner, a new array response vector hₜ is always stored in the communication section 13.

The method for generating the pseudo reception SRS from the array response vector hₜ is described below. The pseudo reception SRS in the frequency band of the non-associated downlink radio resource allocated to the target communication terminals 2 is generated based on the array response vector hₜ of each of the RB bands included in the frequency band, and known signal composed of a plurality of complex symbols. The known signal is referred to as a “pseudo signal generation known signal”.

The pseudo signal generation known signal which is used for generating the pseudo reception SRS in the frequency band of the non-associated downlink radio resources is composed of a plurality of complex symbols corresponding to the plurality of sub-carriers included in the frequency band. Further, when the pseudo reception SRS is generated, the plurality of the same pseudo signal generation known signals corresponding to the plurality of antennas 110a is used.

As the code sequence of the plurality of complex symbols composing the pseudo signal generation known signal adopts, for example, a ZC (Zadoff-Chu) sequence similarly to the SRS. As the code sequences of the pseudo signal generation known signal, a code sequence different from that of the SRS may be used.

The pseudo reception SRS in the frequency bands of the non-associated downlink radio resources allocated to the target communication terminals 2 is composed of pseudo reception signal vectors of the plurality of sub-carriers included in the frequency bands. The pseudo reception signal vector of a sub-carrier included in the frequency band of the non-associated downlink radio resource is obtained by generating in a pseudo manner the complex signal vector composed of SRS symbols (the SRS per one sub-carrier) that is received by the plurality of antennas 110a and is transmitted in the sub-carrier by the target communication terminal 2. The pseudo reception signal vector Qⱼ of a sub-carrier j included in the frequency band of the non-associated downlink radio resource is expressed by the following formula (2).

[Mathematical Formula 2]

Qⱼ=h_{t,j}×Pⱼ (2)

h_{t,j} represents the array response vector hₜ of the RB band to which the sub-carrier j belongs. Further, Pⱼ represents the complex signal vector composed of complex symbols corresponding to the sub-carrier j in the plurality of pseudo signal generation known signals corresponding to the plurality of antennas 110a, respectively.

The reception weight processing section 124 generates the pseudo reception signal vectors of the plurality of sub-carriers included in a frequency band of the non-associated downlink radio resource using the formula (2) so as to generate the pseudo reception SRS in the frequency band.

In such a manner, the reception weight processing section 124 generates pseudo reception SRSs in the frequency bands of each of the non-associated downlink radio resources in the association unit period 550.

When generating the pseudo reception SRS in the frequency band of the non-associated downlink radio resource, the reception weight processing section 124 adds the pseudo reception SRS as a desired wave component to a reception signal (referred to hereinafter as “desired wave non-including reception signal”) to be received in the frequency band of the non-associated downlink radio resource in the uplink radio resource for SRS corresponding to the downlink radio resource 560 to which the non-associated downlink radio resource belongs so as to generate the pseudo desired wave including reception signal.

The desired wave non-including reception signal is composed of reception signal vectors R₁ of the plurality of sub-carriers included in the frequency band of the non-associated downlink radio resource. The reception signal vector R₁ of a certain sub-carrier is the complex signal vector composed of reception symbols corresponding to the sub-carrier received by the plurality of antennas 110a. Hereinafter, the reception signal vector R₁ of a certain the sub-carrier j is represented by “R_{1,i}”. The reception symbol is a complex symbol that is included in a reception signal to be received by the antenna 110a and modulates one sub-carrier.

Further, the pseudo desired wave-containing reception signal is composed of reception signal vectors R₂ corresponding to the plurality of sub-carriers included in the frequency band of the non-associated downlink radio resource. When the reception signal vector R₂ of a certain sub-carrier j is represented by “R_{2,j}”, the reception signal vector R_{2,j} is expressed by the following formula (3).

[Mathematical Formula 3]

R_{2,j}=R_{1,j}+Qⱼ (3)

The reception weight processing section 124 generates reception signal vectors R₂ of the plurality of sub-carriers included in the frequency band of the non-associated downlink radio resource using the formula (3) so as to generate the pseudo desired wave-containing reception signal. The reception weight processing section 124 generates the pseudo desired wave-containing reception signal of the non-associated downlink radio resource, and calculates the reception weight based on that signal. The transmission weight processing section 123 calculates the transmission weight to be applied to the transmission signal to be transmitting by using the non-associated downlink radio resource based on the reception weight.

As is understood from the above description, past SRS transmitted by the communication terminal 2 in the frequency band of the non-associated downlink radio resource is necessary for the transmission weight to be applied to the transmission signal to be transmitted to the target communication terminal 2 by using the non-associated downlink radio resource. In other words, even if the non-associated downlink radio resource is allocated to the target communication terminal 2, in the case when the target communication terminal 2 does not transmit the SRS in the frequency band of the non-associated downlink radio resources, the array transmission control cannot be performed when the transmission is performed by using the non-associated downlink radio resource. The scheduling executing section 122, therefore, does not allocate the non-associated downlink radio resource including in the frequency direction the frequency band, in which the target communication terminal 2 does not transmit the SRS, to the target communication terminal 2.

<Operation for Scheduling Downstream Radio Resource in the Base Station 1>

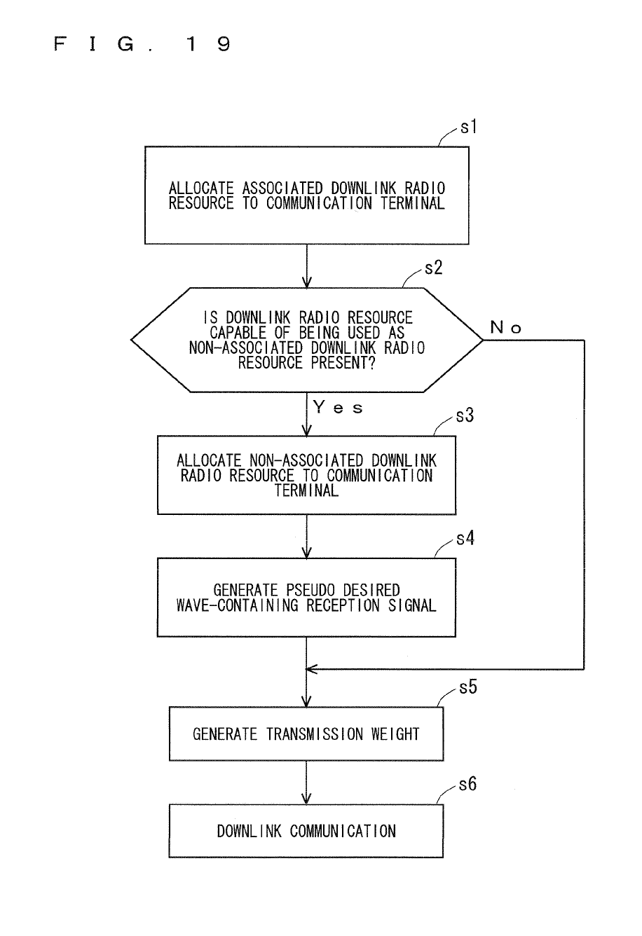

A series of the operation of the base station 1 for scheduling the allocation of the downlink radio resource to the communication terminal 2 by the base station 1 and making the downlink communication based on the scheduling result is described below. FIG. 19 is a flowchart illustrating the series of the operation. The scheduling executing section 122 of the base station 1 performs the scheduling for allocating the use downlink radio resources from the downlink radio resources 560 to the communication terminal 2 in each of the downlink radio resources 560. FIG. 19 illustrates the series of the operation in the base station 1 for scheduling a certain downlink radio resource 560 and making the downlink communication based on the scheduling result. The scheduling of a certain downlink radio resource 560 is performed, for example, in the association unit period 550 one previous to the association unit period 550 including the certain downlink radio resource 560.

As shown in FIG. 19, at step s1, the scheduling executing section 122 allocates the associated downlink radio resource from the downlink radio resource 560 (referred to hereinafter as “the target downlink radio resource 560”) being a target for scheduling to each of the communication terminals 2 for transmitting the SRS in the association unit period 550 including the downlink radio resource 560, namely, each of the SRS most recent transmission terminals 2.

At step s2, the scheduling executing section 122 judges whether the downlink radio resource that can be used as the non-associated downlink radio resource is present in the target downlink radio resource 560. When the determination is made at step s2 that the downlink radio resource which can be used as the non-associated downlink radio resource is not present, step s5, described later, is executed. When all the frequency bands of the uplink radio resource for SRS corresponding to the target downlink radio resource 560 are used for the transmission of the SRS, the downlink radio resource that can be used as the non-associated downlink radio resource is not present.

On the other hand, when the determination is made at step s2 that the downlink radio resource that can be used as the non-associated downlink radio resource is present, at step s3, the scheduling executing section 122 determines the communication terminal 2 to which the non-associated downlink radio resource is allocated as an allocation terminal from the communication terminals 2 for transmitting the SRS, and allocates the non-associated downlink radio resource to the allocation terminal. At step s3, the scheduling executing section 122 determines the allocation terminal based on the communication state between the base station 1 and the communication terminal 2. For example, the scheduling executing section 122 determines the allocation terminal based on proportional fairness (PF) relating to the downlink communication between the base station 1 and the communication terminal 2. The method for determining the allocation terminal according to this embodiment is described in detail below.

The scheduling executing section 122 determines a downlink priority as a priority of the downlink communication in each of the communication target terminals 2 based on the proportional fairness. When determining the downlink priority relating to each of the communication target terminals 2, the scheduling executing section 122 determines the downlink priority for each of the RB bands. A downlink priority DM(n) of the target communication terminals 2 in a certain RB band (the target RB band) at the nth association unit period 550 can be expressed by the following formula (4).

[Mathematical Formula 4]

DM(n)=RD(n)/TD(n) (4)

RD(n) is an available transfer speed in the target RB band in the nth association unit period 550, and represents an expected value of a data amount transmittable to the target communication terminal 2 in the target RB band in the nth association unit period 550 by the base station 1. RD(n) is determined by, for example, based on MCS (Modulation and Coding Scheme) to be used for the downlink communication in the target RB band. The MCS represents a combination of a modulation system and a coded rate of an error correcting code, and a transmission rate is determined according to the MCS. The MCS is determined by SINR (Signal to Interference plus Noisepower Ratio) that is notified to the base station 1 by the communication terminal 2 and relates to a reception signal from the base station 1 in the communication terminal 2. The communication terminal 2 notifies the base station 1 of the obtained SINR as CQI (Channel Quality Indicator) information.

Further, TD(n) represents an average transmission throughput of the base station 1 with respect to the target communication terminal 2 in the target RB band up to the nth association unit period 550, and is expressed by the following formula (5).

[Mathematical Formula 5]

TD(n)=(1−1/Tc)×TD(n−1)+1/Tc×RD(n−1) (5)

Tc represents a constant called a forgetting coefficient.

As is understood from the formulas (4) and (5), the higher a transmission ability at that time is, the higher the downlink priority of the target communication terminal 2 is. Further, the smaller the data amount in the past downlink communication is, the higher the downlink priority is. As a result, while the equality of the data amount in the downlink communication among the plurality of communication terminals 2 is being maintained, the transmission throughput of the base station 1 can be improved.

In such a manner, the scheduling executing section 122 determines the downlink priority of each of the communication target terminals 2 in each of the RB bands.

The scheduling executing section 122, then, specifies the communication target terminal 2 whose downlink priority is the highest in each of the RB bands included in all the downlink radio resources as the non-associated downlink radio resources in the target downlink radio resource 560. The scheduling executing section 122 allocates the non-associated downlink radio resource including the RB band in the frequency direction to the communication target terminal 2 whose downlink priority is the highest in each of the RB bands included in all the downlink radio resources as the non-associated downlink radio resource in the target downlink radio resource 560, from the target downlink radio resource 560. Even if the downlink priority of a certain communication target terminal 2 in the RB band is the highest, when the communication target terminal 2 does not transmit the SRS at all in the RB band, as described above, the non-associated downlink radio resource including the RB band in the frequency direction is not allocated to the communication target terminal 2. As a result, the allocation terminal of the non-associated downlink radio resource as the target downlink radio resource 560 is determined, and the non-associated downlink radio resource is allocated to the allocation terminal.

In the above example, the allocation terminal of the non-associated downlink radio resource is determined by the downlink priority based on the proportional fairness, but another index indicating the communication state between the communication terminal 2 and the base station 1 may be used. For example, the allocation terminal of the non-associated downlink radio resource may be determined by using SINR notified by each of the communication terminals 2 in each of the RB bands of a reception signal in the communication terminal 2 from the base station 1, or by using MCS that is allocated to each of the communication terminals 2 in each of the RB bands.

When the association unit period 550 including the target downlink radio resource 560 appears after step s3, at step s4 the reception weight processing section 124 generates the pseudo desired wave-containing reception signal in the frequency band of the non-associated downlink radio resource allocated to each of the communication target terminals 2 to which each of the non-associated downlink radio resources is allocated at step s3 in the above manner.

At next step s5, the communication section 13 calculates a transmission weight to be set to a transmission signal to be transmitted to each of the communication terminals 2 to which each of the use downlink radio resources is allocated at steps s2 and s3. The communication section 13 generates, in the above manner, the transmission weight based on the reception signal that is received in the frequency band of the associated downlink radio resource in the uplink radio resource for SRS corresponding to the downlink radio resource 560 to which the associated downlink radio resource belongs in the communication terminal 2 to which the associated downlink radio resource is allocated and includes the SRS as a desired wave component from the communication terminal 2.

On the other hand, the communication section 13 generates the transmission weight based on the pseudo desired wave-containing reception signal in the frequency band of the associated downlink radio resource obtained at step s4 for the communication terminal 2 to which the non-associated downlink radio resource is allocated.

At next step s6, the communication section 13 makes the array transmission control on each of the communication terminals 2 to which each of the use downlink radio resources is allocated at steps s2 and s3 based on the transmission weight of each of the communication terminals 2 generated at step s5, and transmits data using the use radio resource allocated to the communication terminal 2.

In the base station 1 according to this embodiment, when the transmission signal is transmitted to the target communication terminal 2 using the non-associated downlink radio resource, the array transmission control is performed based on the pseudo desired wave-containing reception signal. For this reason, the beam can be directed to the target communication terminal 2. Therefore, the transmission signal to be transmitting by using the non-associated downlink radio resource can securely be sent to the target communication terminal 2. Further, in the base station 1, when the second transmission control is performed so that the downlink communication with the communication terminal 2 is performed, the neighboring base station 1 makes the first transmission control so as to be capable of directing the null relating to the transmission directivity at the communication terminal 2 that performs the downlink communication as described above. Therefore, the base station 1 uses the non-associated downlink radio resource for the downlink communication with the communication terminal 2 and simultaneously can direct the beam at the communication terminal 2, and at the same time the neighboring base station 1 can direct the null at the communication terminal 2 that performs the downlink communication using the first transmission control. As a result, while beam forming and null steering are being carried out, more number of the downlink radio resources can be used, and thus the transmission performance of the base station 1 is improved.

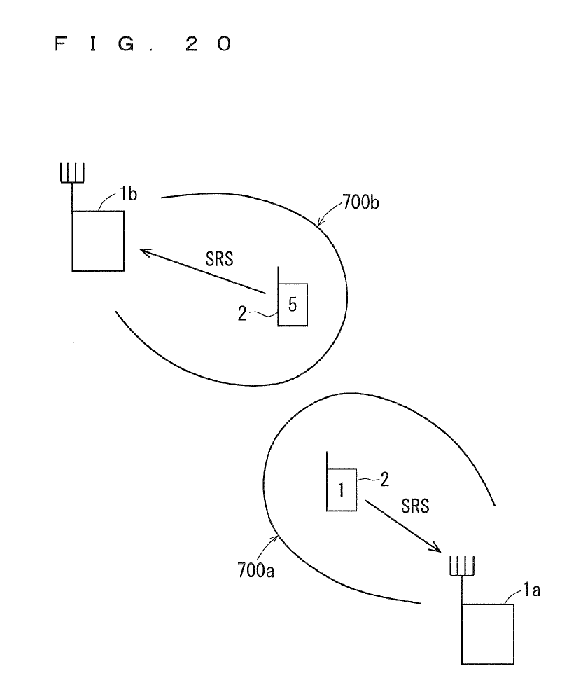

In the second transmission control according to this embodiment, since the communication terminal 2 to which the non-associated downlink radio resource is allocated is determined based on the communication state between the communication terminal 2 and the base station 1, the non-associated downlink radio resource can be allocated to the communication terminal 2 whose state of the communication with the base station 1 is satisfactory. As a result, when the base station 1 transmits a signal to the communication terminal 2 using the non-associated downlink radio resource, even if the neighboring base station 1 cannot intentionally direct the null at the communication terminal 2 performing the communication through the second transmission control, interference to the communication terminal 2 can be repressed. This point is described below with reference to FIG. 20.

FIG. 20 illustrates the base station 1a, and the beam relating to the transmission directivity in the neighboring base station 1b. In an example of FIG. 20, the base station 1a performs the downlink communication with the communication terminal 2 of terminal number 1 using the second transmission control, and the neighboring base station 1b performs the downlink communication with the communication terminal 2 of terminal number 5 using the second transmission control. Further, the communication state between the base station 1a and the communication terminal 2 of terminal number 1 is satisfactory.

In the example of FIG. 20, since the communication state between the base station 1a and the communication terminal 2 of terminal number 1 is satisfactory, the communication terminal 2 of terminal number 1 is likely to be present on a position which is hardly influenced by the interference from each of the communication terminals 2 communicating with the neighboring base station 1b, namely, a position separated from each of the communication terminals 2 communicating with the neighboring base station 1b. Therefore, the communication terminal 2 of terminal number 1 is likely to be present on a position that is separated from the communication terminal 2 of terminal number 5 performing the downlink communication with the neighboring base station 1b through the second transmission control. As a result, when the base station 1a transmits a signal to the communication terminal 2 of terminal number 1, even if the null relating to the transmission directivity of the base station 1a is not directed at the communication terminal 2 of terminal number 5 communicating with the neighboring base station 1b, as shown in FIG. 20, the beam 700a relating to the transmission directivity of the base station 1a is not likely to reach the communication terminal 2 of terminal number 5. When the base station 1a, therefore, performs the downlink communication with the communication terminal 2 of terminal number 1, even if the null cannot be directed at the communication terminal 2 of terminal number 5 communicating with the neighboring base station 1b, the interference to the communication terminal 2 of terminal number 5 can be repressed.

### Modified Example

In the above example, the three uplink radio resources for SRS including the first uplink radio resource for SRS 500a, the second uplink radio resource for SRS 500b and the third uplink radio resource for SRS 500b are used for the transmission of the SRS, but only two of the uplink radio resources for SRS may be used for the transmission of the SRS. In this case, one of the uplink radio resources for SRS to be used for the transmission of the SRS is associated with one of the downlink radio resources 560 including the first downlink radio resource 560a, the second downlink radio resource 560b and the third downlink radio resource 560c, and the other one of the uplink radio resources for SRS to be used for the transmission of the SRS is associated with the downlink radio resources composed of the residual two the downlink radio resources 560.

Further, only one uplink radio resource for SRS in the first uplink radio resource for SRS 500a, the second uplink radio resource for SRS 500b and the third uplink radio resource for SRS 500b may be used for the transmission of the SRS. In this case, the one uplink radio resource for SRS to be used for the transmission of the SRS is associated with the downlink radio resources composed of the first downlink radio resource 560a, the second downlink radio resource 560b and the third downlink radio resource 560c.

In the above example, the SRS to be transmitted in the uplink pilot time slot 352 of the special sub-frame 302 is used for the array transmission control, but the SRS to be transmitted in the last symbol period 304 of the uplink sub-frame 302 may be used instead of or together with the SRS. In this case, in the uplink sub-frame 302, when the uplink radio resource specified by the last symbol period 304 and the plurality of sub-carriers SC0 of the comb-shape that can be used for the transmission of the SRS0 is set as the uplink radio resource for SRS, similarly to the above, the first and second transmission controls can be performed. Further, in the uplink sub-frame 302, when the uplink radio resource specified by the last symbol period 304 and the plurality of sub-carriers SC0 of the comb-shape that can be used for the transmission of the SRS1 is set as the uplink radio resource for SRS, similarly to the above, the first and second transmission controls can be made.

Although the present invention is applied to LTE in the aforementioned examples, the present invention may be applied to other communication systems.

While the invention has been described in detail, the foregoing description is in all aspects illustrative and not restrictive. It is understood that numerous other modifications and variations which have not been illustrated can be devised without departing from the scope of the invention.

### REFERENCE SIGNS LIST

1 base station
2 communication terminal
13 communication section
110a antenna
122 scheduling executing section
500a first uplink radio resource for SRS
500b second uplink radio resource for SRS
500c third uplink radio resource for SRS
560a first downlink radio resource
560b second downlink radio resource
560c third downlink radio resource

1. A base station for communicating with a communication terminal, the base station comprising:
a communication section for communicating with the communication terminal using a plurality of antennas and controlling transmission directivity in the plurality of antennas when downlink communication with the communication terminal is performed; and
a scheduling executing section for determining a communication terminal for downlink communication and allocating, to the communication terminal, a use downlink radio resource to be used by the communication section for the downlink communication with the communication terminal, wherein
an uplink radio resource for known signal which is capable of being used when the communication terminal transmits a known signal, and a downlink radio resource, which is associated with the uplink radio resource for known signal and is capable of being used when the communication section performs downlink communication with the communication terminal are determined,
when the scheduling executing section allocates the use downlink radio resource including a frequency band included in a transmission frequency band of the known signal in a frequency direction to the communication terminal that transmits the known signal using at least a part of the uplink radio resource for known signal, the scheduling executing section executes an allocating process for allocating the use downlink radio resource from the downlink radio resource associated with the uplink radio resource for known signal to the communication terminal,
when the scheduling executing section executes the allocating process on the communication terminal transmitting the known signal using at least a part of the uplink radio resource for known signal, the communication section controls the transmission directivity in the plurality of antennas based on a reception signal including the known signal as a desired wave component received by at least part of the uplink radio resource for known signal when the downlink communication with the communication terminal is performed by using the use downlink radio resource,
when the scheduling executing section allocates the use downlink radio resources including in the frequency direction a frequency band, in which the known signal is not received by the uplink radio resource for known signal, from the downlink radio resource associated with the uplink radio resource for known signal to the communication terminal, the communication section controls the transmission directivity in the plurality of antennas based on a new reception signal obtained by generating a known signal received from the communication terminal in the frequency band of the use downlink radio resource in a pseudo manner when performing the downlink communication with the communication terminal using the use downlink radio resource and by adding the pseudo known signal as a desired wave component to the reception signal received in the frequency band of the use downlink radio resource in the uplink radio resource for known signal.

2. The base station according to claim 1, wherein
when the scheduling executing section allocates the use downlink radio resource including in the frequency direction the frequency band, in which the known signal is not received by the uplink radio resource for known signal, from the downlink radio resource associated with the uplink radio resource for known signal to the communication terminal, the scheduling executing section determines the communication terminal to which the use downlink radio resource is allocated based on a communication state of the downlink communication between the base station and the communication terminal.

3. The base station according to claim 2, wherein
when the scheduling executing section allocates the use downlink radio resource including in the frequency direction the frequency band, in which the known signal is not received by the uplink radio resource for known signal, from the downlink radio resource associated with the uplink radio resource for known signal to the communication terminal, the scheduling executing section determines the communication terminal to which the use downlink radio resource is allocated based on proportional fairness of the downlink communication between the base station and the communication terminal.
